(19) United States
(12) Patent Application Publication
(10) Pub. No.: US 2026/0050943 A1
(43) Pub. Date: Feb. 19, 2026

(54) SYSTEMS AND METHODS FOR UNIFYING DATA ACROSS PLATFORMS

(71) Applicant: Wells Fargo Bank, N.A., San Francisco, CA (US)

(72) Inventor: Stephen Paulos, San Francisco, CA (US)

(73) Assignee: Wells Fargo Bank, N.A., San Francisco, CA (US)

(21) Appl. No.: 18/807,700

(22) Filed: Aug. 16, 2024

(51) Int. Cl. G06Q 30/0226; G06Q 30/0207; G06Q 40/02

(52) U.S. Cl. CPC G06Q 30/0229; G06Q 30/0236; G06Q 40/02

(57) ABSTRACT

Systems, computer-readable media, and methods for synchronizing or linking accounts or exchanges are provided. One method includes identifying an exchange between a user and a merchant and determining the exchange is unlinked with a provider account. The method may further include generating actionable elements corresponding with the unlinked exchange, and at least one of the actionable elements may correspond with linking or registering an account of the user with the merchant. The method may including providing the actionable elements to a GUI of a provider application, receiving a selection of elements corresponding with a request to link or register, and establishing a data communications link with a merchant computing system. The method may further including linking the provider account of the user with the account of the user with the merchant and updating content of the actionable elements to indicate a successful linking.

### TECHNICAL FIELD

The present disclosure relates to the field of providing interoperability between accounts of users across entities. More particularly, the aspects and embodiments of the present disclosure relate to linking or synchronizing user data and/or accounts across multiple platforms.

### BACKGROUND

In a networked environment such as the internet, users and entities such as individuals, providers, and merchants, exchange data. The exchanges can be linked to accounts of the users and entities. However, user and entity accounts can be fragmented across various platforms, and users and entities may lose access to such accounts or be unaware of account-related opportunities due to this fragmentation. Further, this fragmentation leads to network-occupying usage when users attempt to identify account-related opportunities through aimless search queries. Additionally and while performing the search queries, data security may be compromised as the user is repeatedly submitting their credential(s) to various platforms while trying to identify account-related opportunities. Thus, there is a desire to link multiple accounts of multiple entities and identify corresponding account-related opportunities in a processing-efficient manner.

### SUMMARY

One embodiment relates to a method. The method can include identifying, by one or more processing circuits, at least one first exchange between a user and a first merchant based on exchange history data of the user. The at least one first exchange can be linked to a provider account of the user with a provider. The method can include determining, by the one or more processing circuits, that the first merchant corresponds to an exchange rewards system enrolled with the provider. In response to identifying at least one first exchange, the method can include determining, by the one or more processing circuits, that the at least one first exchange is a first unlinked exchange of the provider account and the first merchant. The method can include generating, by the one or more processing circuits, one or more actionable elements corresponding with the first unlinked exchange, wherein at least one of the one or more actionable elements can correspond with linking the provider account of the user with a first account of the user with the first merchant or registering a new account of the user with the first merchant. The method can include providing, by the one or more processing circuits, the one or more actionable elements to a graphical user interface (GUI) of a provider mobile application associated with the provider. The method can include receiving, by the one or more processing circuits, a selection of the one or more actionable elements corresponding with a first request to link the provider account of the user with the first account of the user with the first merchant or register the new account of the user with the first merchant. The method can include establishing, by the one or more processing circuits, a data communications link with a merchant computing system associated with the first merchant. The method can include linking, by the one or more processing circuits, the provider account of the user with the first account or the new account of the user and with the exchange rewards system associated with the first merchant. The method can include updating, by the one or more processing circuits, content of the one or more actionable elements of the GUI indicating a successful linking of the first account or the new account to the provider account.

Another embodiment relates to a system. The system can include one or more processing circuits comprising one or more processors coupled to one or more memory devices, and the one or more processing circuits can be configured to identify at least one first exchange between a user and a first merchant based on exchange history data of the user. In some implementations, the at least one first exchange can be linked to a provider account of the user with a provider. The system can include determining, by the one or more processing circuits, that the first merchant corresponds to an exchange rewards system enrolled with the provider. In response to identifying at least one first exchange, the one or more processing circuits can determine that the at least one first exchange is a first unlinked exchange of the provider account and the first merchant. The one or more processing circuits can generate one or more actionable elements corresponding with the first unlinked exchange, wherein at least one of the one or more actionable elements corresponds with linking the provider account of the user with a first account of the user with the first merchant or registering a new account of the user with the first merchant. The one or more processing circuits can provide the one or more actionable elements to a graphical user interface (GUI) of a provider application associated with the provider. The one or more processing circuits can receive a selection of the one or more actionable elements corresponding with a first request to link the provider account of the user with the first account of the user with the first merchant or register the new account of the user with the first merchant. The one or more processing circuits can establish a data communications link with a merchant computing system associated with the first merchant. The one or more processing circuits can link the provider account of the user with the first account or the new account of the user with the first merchant and with the exchange rewards system associated with the first merchant. The one or more processing circuits can update the content of the one or more actionable elements of the GUI indicating a successful linking of the first account or the new account to the provider account.

Still another embodiment relates to a non-transitory computer readable medium (CRM) including one or more instructions stored thereon that, when executed by one or more processing circuits, cause the one or more processing circuits to perform operations including identifying at least one first exchange between a user and a first merchant based on exchange history data of the user. In some embodiments, the at least one first exchange can be linked to a provider account of the user with a provider. The instructions can cause the one or more processing circuits to determine that the first merchant corresponds to an exchange rewards system enrolled with the provider. In response to identifying at least one first exchange, the instructions can cause the one or more processing circuits to determine that the at least one first exchange is a first unlinked exchange of the provider account and the first merchant. The instructions can cause the one or more processing circuits to generate one or more actionable elements corresponding with the first unlinked exchange, wherein at least one of the one or more actionable elements corresponds with linking the provider account of the user with a first account of the user with the first merchant or registering a new account of the user with the first merchant. The instructions can cause the one or more processing circuits to provide, to a user device associated with the user, the one or more actionable elements to a graphical user interface (GUI). The instructions can cause the one or more processing circuits to receive a selection of the one or more actionable elements corresponding with a first request to link the provider account of the user with the first account of the user with the first merchant or register the new account of the user with the first merchant. The instructions can cause the one or more processing circuits to establish a data communications link with a merchant computing system associated with the first merchant. The instructions can cause the one or more processing circuits to link the provider account of the user with the first account or the new account of the user with the first merchant. The instructions can cause the one or more processing circuits to update the content of the one or more actionable elements of the GUI indicating a successful linking of the first account or the new account.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the embodiments may be combined with one or more features of a different aspect of the embodiments. Moreover, additional features may be recognized in certain embodiments and/or implementations that may not be present in all embodiments or implementations.

### BRIEF DESCRIPTION OF THE FIGURES

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

FIG. 1 is a block diagram depicting an example of a computing environment with a provider exchange system, according to some arrangements;

FIG. 2 is a flowchart for a method for linking or synchronizing accounts and exchanges, according to some arrangements;

FIG. 3 is a block diagram illustrating an example computing system suitable for use in the various arrangements described herein; and

FIGS. 4A-4C are example graphical user interfaces depicting an application user interface, according to some arrangements.

It will be recognized that some or all the Figures are schematic representations for purposes of illustration. The Figures are provided for the purpose of illustrating one or more embodiments with the explicit understanding that they will not be used to limit the scope or the meaning of the claims.

### DETAILED DESCRIPTION

Referring generally to the Figures, the systems, apparatuses, and methods disclosed herein relate to integrating data and facilitating system interoperability. In many systems, linking and synchronizing user accounts and/or exchanges (e.g., transactions) across different entities (e.g., merchants) with a provider introduces technical challenges and inefficiencies. For examples, users may have multiple merchant accounts as various merchants advertise and promote merchant rewards programs and enroll new users. Users may accumulate rewards through spending or other activity associated with their merchant accounts, but users may be unable to access their merchant accounts or otherwise be unaware of rewards/loyalty points accumulation for various reasons, resulting in unused rewards and redemption opportunities. For example, a user may have forgotten that the user has a merchant account with a particular merchant. Since merchant rewards earned through one merchant are typically managed and/or redeemed for spending in a separate environment from merchant rewards earned through another merchant, it can be challenging for a user with multiple merchant accounts to synchronize or manage these accounts due to their fragmentation across multiple platforms. This challenge is further complicated when a user is unaware that they have a merchant account, unable to locate a preexisting merchant account, or unable to track or otherwise manage a merchant account.

The systems, computer-readable media, and methods described herein provide technical advantages by improving the linking and synchronizing of user data and/or accounts across multiple platforms, which in some examples correspond to multiple merchants. One technical benefit is the reduction in computational load and memory usage on various computing devices, such as mobile devices. In traditional systems, the computational demand from loading multiple applications and web interfaces on a single device when linking accounts or exchanges imposes a resource load on devices with limited processing power and memory, such as mobile devices, resulting in degraded performance and increased battery consumption. These inefficiencies may degrade a user experience by increasing the computational load and memory usage of the device, leading to slower performance (e.g., longer loading times) and quicker battery drain. By consolidating account management tasks into a single or limited number of interfaces, users can link accounts and exchanges without loading and switching between multiple separate applications and web portals (e.g., visiting and accessing multiple merchant account websites), thereby reducing the processing power and memory utilized when synchronizing accounts and data. That is, consolidating data synchronization execution into a unified interface reduces the need to load and manage multiple applications simultaneously, thus decreasing the overall processing power required. Additionally, data synchronization reduces redundant data storage and handling operations, leading to lower memory usage on the device. As described herein, this consolidation can minimize the strain on computing device resources, leading to faster performance and extended battery life. Furthermore, the determination of account authorization statuses and the integration of information into a unified interface improves data synchronization and consistency by reducing the likelihood of errors and discrepancies that can arise from fragmented account management. The disclosed systems, computer-readable media, and methods provide a technically improved graphical user interface while technologically improving the computational efficiency and resource management of resource-limited devices (e.g., mobile phones).

The systems, computer-readable media, and methods described herein also provide technical improvements by enhancing data security and privacy in the synchronization of user data across multiple platforms. By utilizing a secure and centralized system for linking and synchronizing data, users may access various services and/or products without repeatedly entering sensitive login credentials across various platforms. This minimizes the exposure of sensitive data, such as usernames, passwords, and account details, thereby lowering the risk of interception and unauthorized access. Additionally, the systems, computer-readable media, and methods described herein can continuously (e.g., real-time, near real-time, periodically) verify authorization statuses through secure data communications links to process sensitive information in a controlled and protected environment. The use of secure data communications links can reduce the attack surface for potential cyber threats and strengthen the overall security posture of the system. Moreover, the consolidation of data synchronization processes into a unified, secure interface can facilitate the implementation of security measures, such as encryption and multi-factor authentication, further safeguarding user data. Secure data communication links between the provider and platform systems can also be used to facilitate the exchange of sensitive information, such as transaction data and reward information, and the use of such links may further reduce the risk of data breaches. These technical improvements contribute to a more secure and resilient system for synchronizing user accounts and exchanges that protects against data breaches and enhances user privacy.

The systems, computer-readable media, and methods described herein offer further technical benefits by improving the process of synchronization and real-time data processing. By centralizing the retrieval and analysis of data across multiple sources, the systems, computer-readable media, and methods described herein can relatively accurately analyze and determine a loyalty or reward benefit eligibility and calculate or determine one or more reward amounts without manual intervention, which can reduce the processing time and computational resources required to facilitate reward programs, particularly on mobile devices with limited capabilities. Further, the aspects and embodiments described herein can consolidate information into a unified interface so users can access data without navigating or launching multiple applications, thereby reducing memory usage on user devices. Additionally, the disclosed systems, computer-readable media, and methods described herein may identify linked and unlinked data between the provider and third-party sources and further notify users of status updates (e.g., user reward status), thereby improving data transmission and integrity by assisting users in avoiding missed and/or unclaimed benefits (e.g., rewards). The systems, computer-readable media, and methods disclosed herein thus improve system interoperability, provide accurate information, and reduces the computational load on both the provider and user devices.

The systems, computer-readable media, and methods described herein offer technical benefits by enhancing graphical user interfaces (GUIs) for data visualization. By integrating data visualization techniques, the systems, computer-readable media, and methods described herein provide consolidated information from multiple sources in a user-friendly and intuitive manner. Further, the systems, computer-readable media, and methods described herein facilitate access and understanding of user data by providing users a unified application to link multiple accounts (e.g., without the user navigating through multiple applications or websites to access such information). The systems, computer-readable media, and methods described herein may further utilize dynamic UI components that update in real-time to reflect recent exchange data and reward calculations, thereby providing users with immediate or substantially immediate feedback. Additionally, the implementations may be configured for optimal performance and usability across various devices, including smartphones and tablets with limited processing power. Thus, the systems and methods disclosed herein further improve system interoperability, user interaction processes, and facilitate accurate access to information through GUIs.

According to the present disclosure, systems, computer-readable media, and methods are provided to assist a user or customer of a provider institution, such as a financial institution (FI), in identifying rewards or benefits that the customer may have forgotten about or be unaware of at one or more third parties (e.g., merchants). The provider institution computing system addresses the issue where the customer or user may have multiple merchant accounts and accumulated rewards due to merchants encouraging enrollment and the user, however, struggling to identify (or otherwise unaware) and/or manage such accounts. Users may often be unaware of rewards accumulation, leading to missed rewards redemption opportunities. The systems and methods described herein identify these hidden or forgotten rewards balances and synchronize various accounts to selectively provide reward opportunities to users who might otherwise lose out on such benefits. For example, one embodiment of the present disclosures relates to a system for partnering with merchants in a rewards transfer program and reviewing the customer's transaction history, such as credit card statements, to identify transactions with the partnered merchants. In response to identifying a transaction or “exchange” between user and a third-party (e.g., a merchant) based on the exchange history data, a provider institution computing system can determine whether the exchange is linked to the provider account of the user. If the provider institution computing system determines that the exchange corresponds with a merchant account that is unlinked with the provider account, the provider institution computing system generates graphical user interface (GUI) elements or “actionable elements” corresponding with the unlinked exchange and provides these elements to the user via the GUI. These actionable elements may include prompts to link a merchant account or register a new account with the provider institution associated with the provider institution computing system. Upon receiving a selection of one of the GUI elements, the provider institution computing system can establish a data communications link with the merchant's computing system to facilitate the linking process or account creation/linking process. The provider institution computing system can further update the content of the actionable elements on the GUI to indicate a successful linking of the account.

An example may be described as follows. A customer, Jane Doe, frequently shops at a partnered electronics retailer but has forgotten to link her rewards account with this retailer to the provider institution computing system and is unaware of the existence or status of her rewards account. Jane uses a mobile banking app (also referred to as a provider institution mobile app) on her phone provided by the provider institution. The provider institution computing system may selectively review Jane's transaction history (e.g., transactions using a credit or debit card issued by the provider institution) and identify multiple purchases with the electronics retailer. Since the account is not linked, the provider institution computing system may generate and provide a prompt to Jane through the app with a message: “Do you have an account with [Electronics Retailer]? If so, please link it to track your rewards.” The message may be accompanied by a button labeled “Link Account.” The provider institution computing system may also provides a summary list of other unlinked merchant accounts, such as rewards accounts from a grocery store, a bookstore, and an airline, and asks Jane which accounts she would like to link. Jane taps the “Link Account” button for the electronics retailer. The provider institution computing system establishes a data communications link with the retailer's computing system to provide account data (e.g., authentication information such as user logins) to perform the linking process. Once the linking is successful, a GUI displayed on the mobile banking app updates to indicate the successful linking of Jane's rewards account with the electronics retailer to inform her that the accounts have been linked for rewards conversion/redemption.

As used herein, an “exchange” refers to a transaction or interaction involving the transfer of value between two or more parties. For example, exchanges can include, but are not limited to, financial transactions such as payments, refunds, etc. The exchanges may be effectuated via a mobile application, a credit card, etc. and occur at various locations, such as at a merchant's point of sale (e.g., credit card transactions, mobile wallet payments, etc.). As described herein, an “exchange” can refer to the accrual and/or redemption of recognition points, loyalty points, rewards, and/or membership benefits (e.g., points earned from a purchase, membership tier upgrades, etc.). Generally, performing or facilitating an exchange can include an initiation of the transaction (e.g., by the user from spending at various places, by a merchant in response to a user achieving a predefined points balance, etc.), a validation and/or authorization of the transaction by the provider and/or merchant, and an update of account information to reflect the completed transaction (e.g., a modification of a user's account or other data based on redeeming or converting rewards). In another example, an “exchange” can include, but is not limited to, a crediting or allocation of a sum or quantity of exchange rewards (e.g., 20 points) to a user (e.g., to a user's merchant account), a conversion of rewards or benefits of a first type to rewards or benefits of a second type (e.g., from rewards redeemable with a first merchant to a rewards redeemable with a second merchant), and so on.

It should be understood that while the present disclosure is explained mainly in regard to identifying and managing accounts between users and entities such as merchants and providers, such a description is not meant to be limiting. The principles described herein may be applicable to various other types of data management and synchronization systems and/or methods. All such variations are intended to fall within the scope of the present disclosure.

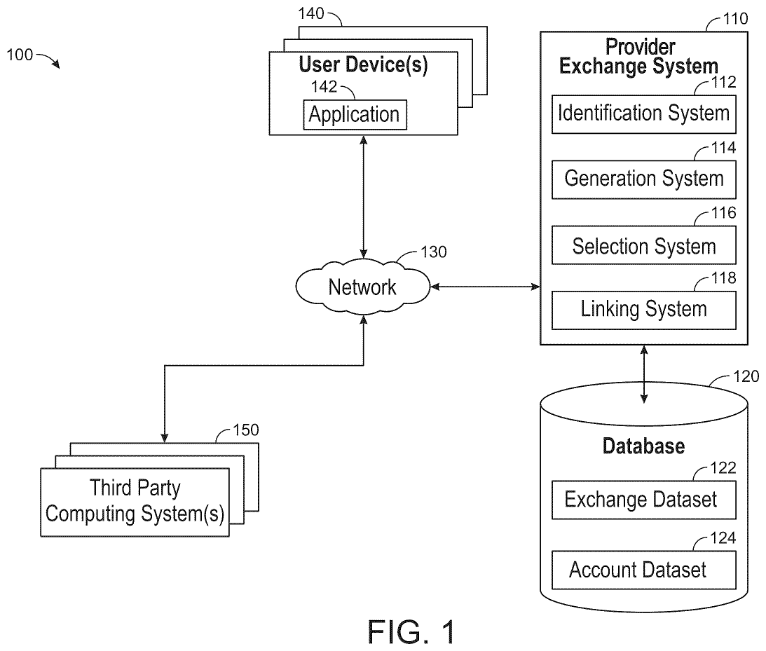

Referring now to FIG. 1, a block diagram depicting an example of a computing environment 100 with a provider exchange system 110 is shown, according to some arrangements. As shown, the environment 100 includes the provider exchange system 110, a database 120, a network 130, one or more user device(s) 140, and one or more third party computing system(s) 150. The provider exchange system 110 may include an identification system 112, a generation system 114, a selection system 116, and a linking system 118. The provider exchange system 110 may include or, as shown, be communicatively coupled or linked to the database 120, and the database 120 may include an exchange dataset 122 and an account dataset 124. The user device(s) 140 may include an application 142 (also referred to herein as a “provider application” and “provider mobile application”). Although the various computing elements of FIG. 1 may be described in the singular form below (e.g., network 130, user device 140, etc.), it should be understood that the computing environment 100 may include two or more of any device/system described herein (e.g., two or more network(s) 130, two or more user device(s) 140, etc.).

In various arrangements, components of the environment 100 communicate over network 130. Network 130 may include computer networks such as the Internet, local, wide, metro or other area networks, intranets, satellite networks, other computer networks such as voice or data mobile phone communication networks, combinations thereof, or any other type of electronic communications network. Network 130 may include or constitute a display network. In various implementations, network 130 facilitates secure communication between components of system 100. As a non-limiting example, network 130 may implement transport layer security (TLS), secure sockets layer (SSL), hypertext transfer protocol secure (HTTPS), and/or any other secure communication protocol.

In some arrangements, network 130 may be composed of various network devices (nodes) communicatively linked to form one or more data communication paths between participating devices. The network 130 can facilitate communication between the various nodes, such as the provider exchange system 110, database 120, one or more user device(s) 140, and one or more third party computing system(s) 150 (e.g., using an OSI layer-4 transport protocol such as the User Datagram Protocol (UDP), the Transmission Control Protocol (TCP), Stream Control Transmission Protocol (SCTP), etc.). Each networked device may include at least one network interface for receiving and/or transmitting data, typically as one or more data packets. An illustrative network 130 is the Internet; however, other networks may be used. Network 130 may be an autonomous system (AS), i.e., a network that is operated under a consistent unified routing policy (or at least appears to from outside the AS network) and is generally managed by a single administrative entity (e.g., a system operator, administrator, or administrative group).

The provider exchange system 110 may be owned by, or otherwise associated with, a provider, which is also referred to as a provider institution. The provider institution may be a provider of goods and/or services. In one embodiment and as shown, the provider institution may be a financial institution, such as a commercial or private bank, credit union, investment brokerage, and so on. The provider institution may maintain one or more accounts for individual persons and/or entities. The provider exchange system 110 may also be configured to manage accounts and authorize transactions involving withdrawals and/or deposits from accounts (e.g., a checking account) associated with customers. In one example, the provider exchange system 110 can identify user accounts with third parties and analyze transactions (e.g., exchanges) with these third parties to identify rewards opportunities. That is, the provider exchange system 110 can automatically perform account-related tasks for the provider institution, such as monitoring exchange histories, determining eligible transactions, and linking various third-party user accounts, as further described herein.

In the example shown, the provider exchange system 110 includes a plurality of sub-processing systems, shown as the identification system 112, generation system 114, selection system 116, and linking system 118 for synchronizing and linking a user's merchant accounts with the user's provider account. In some arrangements, the provider exchange system 110 and/or included sub-systems (e.g., identification system 112, generation system 114, etc.) may include at least one processing system or device, such as a computing device having at least one processing circuit configured to execute instructions stored in a memory device to perform one or more operations described herein. The processing circuit may include a processor, such as a microprocessor, an application specific integrated circuit (ASIC), a field-programmable gate array (FPGA), etc., or combinations thereof. The processing circuit may include a memory, and the memory may include, but is not limited to, electronic, optical, magnetic, or any other storage or transmission device capable of providing processor(s) with program instructions. The instructions may include code from any suitable computer programming language such as, but not limited to, ActionScript®, C, C++, C #, HTML, Java®, JavaScript®, Perl®, Python®, Visual Basic®, and XML.

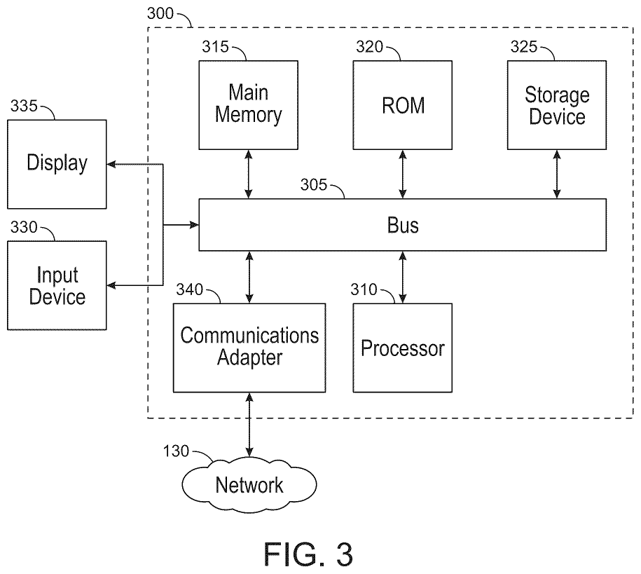

In some arrangements, the provider exchange system 110, database 120, user device 140, and/or third party computing systems 150 can include the structural components the computing device described in FIG. 3, which can be used to run or otherwise implement the various functionalities and/or features described herein, such as linking third-party user accounts with a provider account. In other arrangements, the provider exchange system 110 may be a server, distributed processing cluster, cloud processing system, or any other computing device or system. The provider exchange system 110 may include or execute at least one computer program or at least one script. In some implementations, provider exchange system 110 includes combinations of software and hardware, such as one or more processors configured to execute one or more scripts. For example, the provider exchange system 110 may include one or more processing circuits (e.g., a processing circuit) including a processor and memory, and the memory may have instructions stored thereon that, when executed by the processor, cause the processing circuit to perform the various operations described herein. The operations described herein may be implemented using software, hardware, or a combination thereof. As mentioned above and herein, the processor(s) included in the processing circuit(s) of the provider exchange system 110 may include a microprocessor, ASIC, FPGA, etc., or combinations thereof, or may include a multi-core processor or an array of processors. The memory included in the processing circuit of the provider exchange system 110 may include, but is not limited to, electronic, optical, magnetic, or any other storage devices capable of providing a processor or processing circuit with program instructions. For example, the memory may include a floppy disk, CD-ROM, DVD, magnetic disk, memory chip, ROM, RAM, EEPROM, EPROM, flash memory, optical media, or any other suitable memory from which processor(s) can read instructions.

In some arrangements, in addition to the processing circuit(s), the provider exchange system 110 may include and/or be communicatively coupled to one or more databases (e.g., database 120). The databases may be structured as a data repository that is configured to store data, such as exchange history data or account data. For example, the database 120 can include data structures for storing information such as, but not limited to, exchange data and/or exchange information (e.g., exchange amount or transaction amount, exchange date or transaction date, exchange rewards data, merchant exchange data, etc.), account data and/or account information (e.g., linked accounts, unlinked accounts, existing/new accounts with providers/merchants, lists of accounts, account credentials including merchant usernames and merchant passcodes, etc.), rewards data or information (e.g., eligible exchanges or transactions, merchant parameters such as exchange rewards rate, exchange rewards totals, calculated rewards, etc.), and/or other data or information. The database 120 can be part of the provider exchange system 110, or a separate component that the provider exchange system 110 and/or the user device 140 can access via the network 130. The database 120 can also be distributed throughout environment 100. For example, the database 120 can include multiple databases associated with the provider exchange system 110, a client device (E.g., user device 140), or both. Database 120 may include one or more storage mediums. The storage mediums may include, but are not limited to, magnetic storage, optical storage, flash storage, and/or RAM. In some arrangements, the provider exchange system 110 may implement or facilitate various APIs to perform database functions (i.e., managing, synchronizing, or linking data stored in database 120). The APIs can be but are not limited to SQL, ODBC, JDBC, NOSQL and/or any other data storage and manipulation API.

In some arrangements, the database 120 may include an exchange dataset 122 and an account dataset 124. The exchange dataset 122 may include data/information, referred to as exchange history data, that provides an indication of a list of exchanges (e.g., transactions), data regarding various exchanges or “exchange information” (e.g., transaction or exchange date, merchant, exchange amount, etc.), and various additional data related to exchanges between one or more of a provider, merchant, and user. In some arrangements, the provider exchange system 110 may access the exchange dataset 122 of the database 120 to determine or identify at least one exchange for synchronizing or linking third-party data and/or third-party accounts (e.g., merchant accounts between a user and one or more third-party merchants such as vendors) to a user's provider data and provider account(s) (e.g., a user's account at the provider institution). Further, the provider exchange system 110 may communicate with the database 120 (e.g., locally or via the network 130, etc.) to update stored information included in the exchange dataset 122 by, for example, adding data relating to a new exchange to the exchange dataset 122 in response to identifying a new exchange between a user and a provider or merchant. In another example, the provider exchange system 110 may interact with the exchange dataset 122 to cause the exchange dataset 122 to update stored exchange data.

In some arrangements, the account dataset 124 may include similar features and/or functionality as described regarding the exchange dataset 122, but may include account information (e.g., account history data, lists of linked or unlinked accounts, etc.). The account information can refer to accounts of a user with the provider (or provider account). For example, a provider account may refer to an account held by the user with the provider (e.g., entity) that synchronizes exchanges and rewards across multiple merchants. As mentioned above, in the example shown, the provider may provide one or more financial products or services and, as such, the accounts (also referred to as provider accounts or user accounts with the provider), may include but are not limited to checking accounts, savings accounts, money market accounts, demand deposit accounts, certificates of deposit (CDs), individual retirement accounts (IRAs), brokerage accounts, credit card accounts, mortgage accounts, personal loan accounts, home equity lines of credit (HELOCs), educational savings accounts (e.g., 529 plans), etc. The account information may also be received from a third party computing system and include third-party accounts of a user with one or more third parties (e.g., merchant accounts, user accounts with a merchant, etc.), and include, but are not limited to, merchant rewards accounts, loyalty accounts, recognition programs, membership benefits programs, and/or travel and hospitality accounts (e.g., airline frequent flyer programs, hotel loyalty programs, vacation rental accounts, etc.). The third-party accounts of a user may also include, but are not limited to, utility accounts (e.g., electricity, gas, water, internet), healthcare accounts (e.g., patient portals, medical billing accounts), and/or insurance accounts (e.g., policyholder accounts, claim tracking accounts). The account information may also include various additional or alternative accounts involving one or more of the user, providers/financial institutions, merchants, or other entities, including but not limited to joint accounts, business accounts, investment accounts (e.g., brokerage accounts, mutual funds, pension plans), cryptocurrency wallets, and government benefit accounts (e.g., social security accounts, unemployment benefits). In one, in response to identifying an exchange between a user and a merchant, the provider exchange system 110 may query the account dataset 124, which may include a listing of linked or authenticated user accounts linked to the provider institution to determine if the user has authorized provider institution access to a user account with the particular merchant.

In some arrangements, the user device 140 (sometimes, depending on the configuration of the user device, the user device may be referred to herein as an “electronic device,” “mobile device,” or “mobile electronic device”) may be a computing device, personal computer (PC), desktop computer, laptop computer, smartphone, tablet, smart watch, smart sensor, or any other device configured to facilitate receiving, displaying, and interacting with content (e.g., applications, etc.) or data (e.g., exchange data, merchant data, account data, etc.). For example, user device 140 may be a cell phone configured to execute to application 142 to receive and display content and/or actionable elements and to receive user interaction with the content and/or actionable elements. User device 140 may also include an input/output circuit for communicating data over network 130.

In some arrangements, the user device(s) 140 may include an application 142. The user device 140 may include a plurality of applications. In some arrangements, the user device(s) 140 may execute the provider application 142 or another application (e.g., web browser, etc.) to link or synchronize user data, exchanges, and/or accounts between the provider and merchant(s) on behalf of one or more users. For example, the application 142 may be configured to retrieve content from other computing systems and devices over the network 130 for displaying exchange and/or account information to a user with the user device 140. Additionally or alternatively, application 142 may be a mobile application executed by mobile device 140. The application 142 can be a mobile application, such as a mobile banking application, which can be downloaded from an app store, pre-installed, or hard coded into the device's memory.

In the example shown, the application 142 is provided and at least partly supported by the provider institution associated with the provider exchange system 110. Thus, the application 142 may be referred to as a provider application or provider mobile application. As mentioned herein, the provider institution may provide various financial products goods and/or services. As such, the provider institution mobile application 142 may provider various financial tools, such as transaction management, account monitoring, funds transfer, bill payments, and financial planning tools, etc. In some embodiments, the provider institution mobile application 142 can be a part of a mobile banking application associated with the provider institution or a separate application.

In some arrangements, the provider institution mobile application 142 may include a collection of software development tools contained in a package (e.g., software development kit (SDK), application programming interface (API), integrated development environment (IDE), debugger, etc.). For example, the provider institution mobile application 142 may include an application programming interface (API) or a debugger, or an SDK that includes an API, a debugger, an IDE, and so on. In some implementations, provider institution mobile application 142 includes one or more libraries having functions that interface with a particular system software (e.g., iOS, Android, Linux, etc.). As a further example, provider institution mobile application 142 may include a function configured to collect and report data (e.g., exchange data, account data, merchant data, device analytics, etc.), and a user may insert the function into the instructions of provider institution mobile application 142 to cause the function to be called during specific actions of provider institution mobile application 142 (e.g., in response to identifying an exchange).

The provider mobile application 142 can be installed and designed to run on smartphones, tablets, and other mobile devices. The provider mobile application 142 can include a client-side application that interacts with server-side components over the network. The mobile application 142 can be implemented using various programming languages and frameworks, such as Swift or Objective-C for iOS, and Kotlin or Java for Android. The provider mobile application 142 can be packaged and distributed through app stores. In some implementations, the provider mobile application 142 can include a presentation layer (UI/UX), a business logic layer, and a data layer. The presentation layer can handle user interactions and displays data using graphical user interface components. The business logic layer can process user inputs, manages application workflows, and enforces rules and policies. The data layer can manage data storage, retrieval, and synchronization with remote servers. The provider mobile application 142 can utilize device capabilities such as cameras, GPS, accelerometers, and touchscreens. The provider mobile application 142 can operate in online or offline modes, utilizing local storage and caching mechanisms to facilitate functionality when network connectivity is limited. Security measures, such as encryption, authentication, and secure communication protocols, can be implemented to protect user data and ensure privacy.

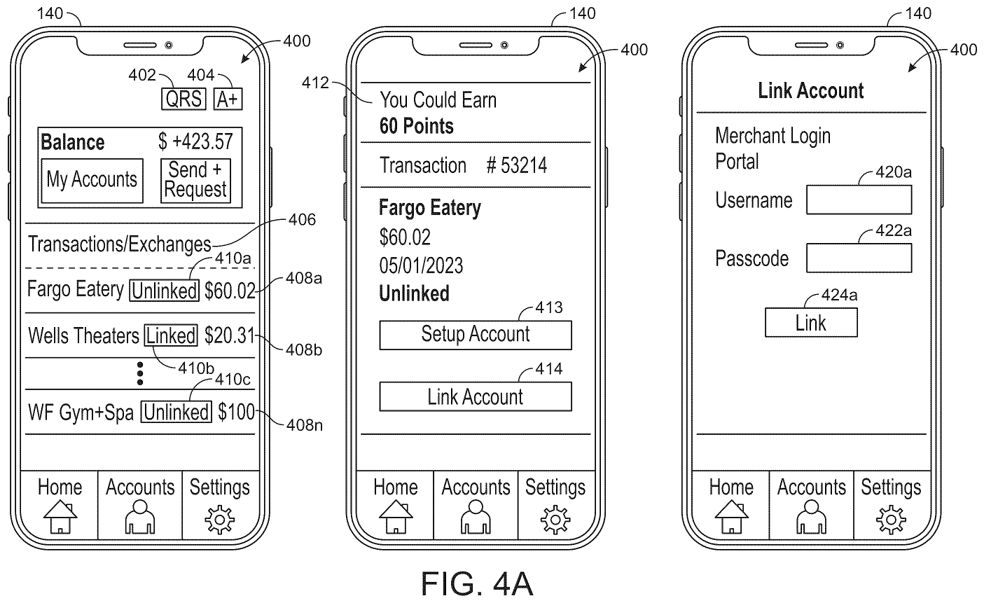

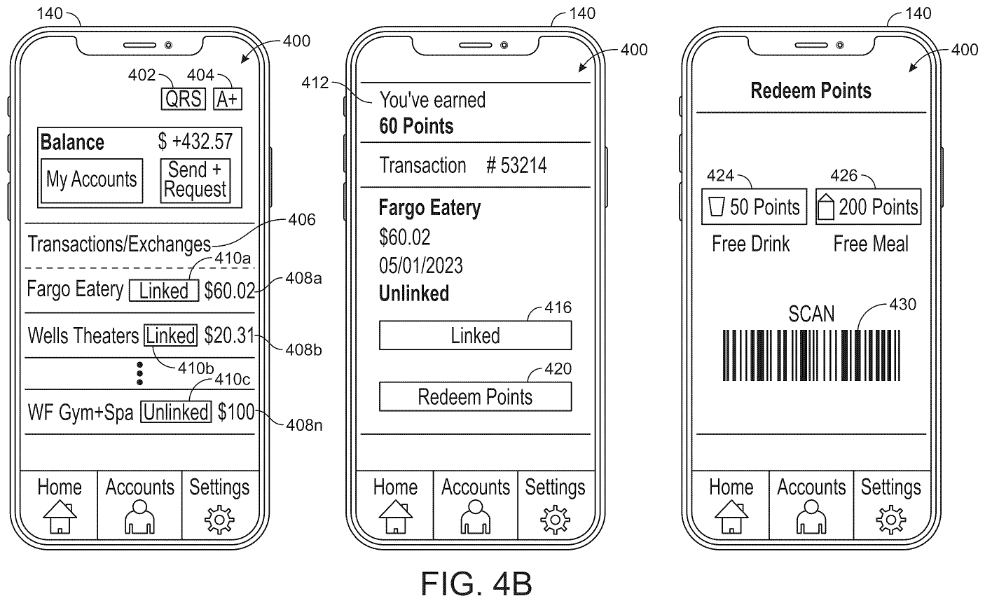

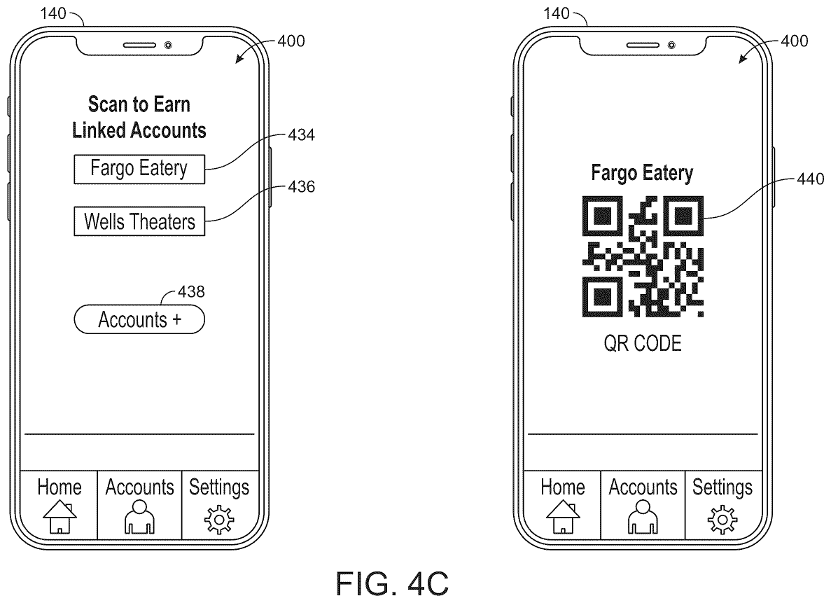

In some arrangements, the user device 140 and application 142 can be configured to provide one or more interfaces (e.g., graphical user interfaces (GUIs)). For example, the provider mobile application 142 may generate and provide the following interfaces: an exchange interface for accessing, viewing, and/or updating exchanges corresponding or involving a user (the provider exchange system 110 may identify exchanges involving the user by examining exchange history associated with the user to identify the exchanges); an account GUI(s) for accessing, viewing, or updating an account corresponding to the user at the provider; and (among potentially others), a reward GUI for accessing, viewing, or updating rewards associated with exchanges. For example, the exchange interface can display a history of all recent transactions (e.g., in a table format for a past predefined amount of time) for the user to access, view, and/or modify exchanges associated with a user's provider account. In another example, the account interface can include a provider-managed list of linked or unlinked accounts associated with the user, which the user has at third parties (e.g., various merchants). As described herein, the user may have additional accounts with other entities, such as third parties (e.g., merchants), and the provider exchange system 110 can link the provider account of the user with various third-party accounts of the user. As described herein, the reward interface can depict a summary of accumulated rewards for the user to access, view, and update their rewards earned from transactions associated with different merchants. In some arrangements, the interfaces may include content items (e.g., for presenting content) and/or actionable elements (e.g., user-selectable or user-interactive features) and be presented via the application 142 Additional details and features of application 142 are described in greater detail below with reference to FIGS. 4A-4C.

In some examples, the user device 140 can provide an interface (e.g., from the generation system 114 of the provider exchange system 110) on a viewport of the user device 140. The viewport refers to a visible area of the graphical user interface through which users can view and interact with user interface content and/or elements. For example, in a mobile application, the viewport displays an initial view of visible content items and/or actionable elements (e.g., menus, forms, data lists, etc.), and users can interact (e.g., scroll or swipe) within the viewport to cause the user device 140 to display an updated view with additional content or elements outside the initial view.

The third-party computing system(s) 150 are associated with third-parties relative to the provider institution associated with the provider exchange system 110. As such, the third parties may include merchants and/or other entities that may provide accounts associated with the user but maintained by third-parties relative to the provider institution. In some arrangements, the various components of the environment 100 may interact with the third-party computing system(s) 150 to link various accounts (e.g., user accounts with third parties or merchants, user accounts with providers, etc.).

For example, the provider exchange system 110 may facilitate a user linking a third party account by providing a login interface to the user by accessing the third party computing system 150 (e.g., merchant computing system). For example, user device 140 may present a login interface from the third party computing system(s) 150 within the application 142 such that the user may enter login credentials (e.g., username, email, phone number, password, passcode, multi-factor authentication input, etc.) within the application 142. Upon successful authentication, the third party computing system(s) 150 may provide an authorization code to the application 142 (e.g., via the network 130), and the provider institution application 142 may communicate the authorization code to the provider exchange system 110 to complete an account linking process (e.g., facilitating provider access to merchant accounts of a user). Further, a user may view displayed content items and/or interact with input elements (e.g., actionable elements with content) presented on the graphical user interface of the application after accessing or communicating with the third party computing system(s) 150. In some arrangements, the provider exchange system 110 may receive data used to update the content items and/or actionable elements via a data communications link (e.g., network 130) between the user device 140 and the third party computing system(s) 150, or via a data communications link between the provider exchange system 110 and third party computing system(s) 150.

The provider exchange system 110 is structured or configured to identify at least one first exchange (e.g., communicated via network 130) between a user and a first third-party, particularly a first merchant, and linked to a provider account of the user based on exchange history data of the user. For example, the provider exchange system 110 may identify at least one first exchange linked to the provider account of the user by receiving exchange history data from the third party computing system 150. In some arrangements, the provider exchange system 110 can determine that the first merchant is part of an exchange rewards program enrolled with the provider. In some arrangements, in response to identifying at least one first exchange, the provider exchange system 110 may determine the at least one first exchange is a first unlinked exchange of the provider account between the first merchant and the user (e.g., as used herein, an “unlinked” exchange refers to an exchange between the user and a merchant, where the user's merchant account with the merchant is not connected or linked with the user's provider account with the provider). Further, the provider exchange system 110 may generate one or more actionable elements corresponding with the first unlinked exchange, and at least one of the one or more actionable elements may correspond with linking a first account of the user with the first merchant (e.g., merchant account) to the user's provider account. In some arrangements, the provider exchange system 110 may provide, to a mobile device of the user (e.g., user device 140), the one or more actionable elements to a graphical user interface (GUI). In other embodiments, the provider mobile application 142 may generate and provide the one or more actionable elements. The provider exchange system 110 may receive a selection (e.g., from the user device 140 via the network 130) of the one or more actionable elements corresponding with a first request to link the first account of the user with the first merchant or register the new first account of the user with the first merchant. In some arrangements, the provider exchange system 110 may establish a data communications link (e.g., network 130) with a merchant computing system of the merchant (e.g., third party computing system 150). The provider exchange system 110 may further link the provider account of the user with the first account or the new first account of the user with the first merchant (e.g., by a user interacting with actionable elements included on a GUI provided by application 142). In some arrangements, the provider exchange system 110 may update content of the one or more actionable elements of the GUI indicating a successful linking of the first account or the new first account.

In some arrangements, the provider exchange system 110 is configured to link the user's provider account to the merchant accounts within the application 142. For example, the provider exchange system 110 can receives a user's credentials (e.g., username, password, etc.) corresponding with the user's merchant account. Further, the provider exchange system 110 can execute an API call to the third party computing system 150 to authenticate the user's credentials and establish a secure connection between the provider exchange system 110 and the third party computing system 150, and the provider exchange system 110 can confirm this connection within the provider mobile application 142. This process can be performed by or within provider mobile application 142 to maintain all interactions and security measures within a single application while adding a second level of security with the third-party credentials. The above example can improve data security by confining linking and other third party interactions within the secure environment of the application 142, which reduces the risk of credential exposure and unauthorized access.

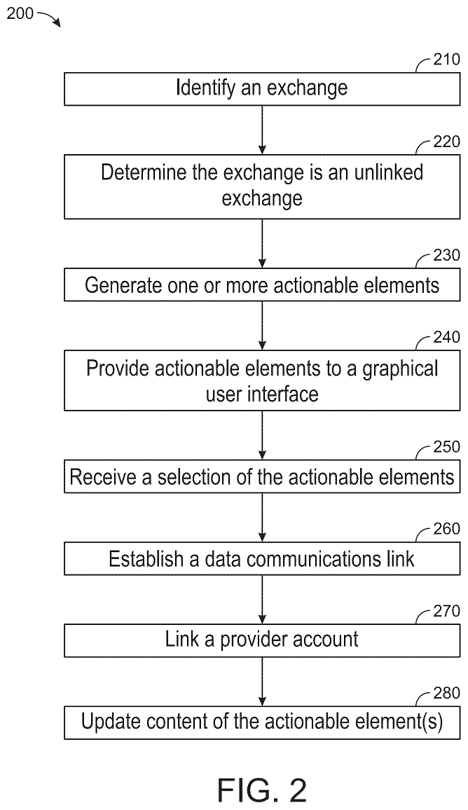

As mentioned above, the provider exchange system 110 may further include one or more systems (e.g., identification system 112, generation system 114, selection system 116, linking system 118, etc.) for synchronizing accounts and exchanges and/or for incorporating the various features and/or functionalities described herein (e.g., for performing one or more steps of method 200 of FIG. 2). The identification system 112 may identify at least one first exchange between a user associated with the provider institution and a first merchant based on exchange history data of the user. In some arrangements, the identification system 112 can determine that the first merchant is part of an exchange rewards program enrolled with the provider. For example, an exchange rewards program may include a merchant system where users can earn points, discounts, or other benefits from transactions with the merchant providing the exchange rewards program. In one example, the exchange rewards program is enrolled with the provider, meaning that the first merchant is part of a group of partnered merchants whose rewards are eligible to be recognized and/or tracked by the provider's platform (e.g., identification system 112). As used herein, determining enrollment may not refer to the actual linking of user accounts (e.g., linking a user's merchant account and/or associated exchange rewards program with a provider account), but instead refers to the identification system 112 determining that the merchant's rewards program is eligible for provider management and/or linking. For example, the identification 112 can determine that the exchange rewards program is compatible with the provider's system, meets various provider requirements for linked accounts, and/or is associated with a partnered merchant of a group of partnered or participating merchants agreeing that the provider can manage the participating merchants'exchange rewards programs. In some arrangements, in response to identifying at least one first exchange, the identification system 112 may determine the exchange is an unlinked exchange of the provider account between the first merchant and the user in various ways, such as querying a dataset including linked accounts (e.g., stored in database 120 or account dataset 124, received from third party computing system(s) 150, etc.) or exchanges (e.g., stored in exchange dataset 122, elsewhere accessible via network 130, etc.), or by interacting with a merchant computing system (e.g., third party computing system 150, etc.) to determine an unlinked, non-existent, or missing user account with the merchant or to determine a corresponding exchange or a related exchange. For example, the identification system 112 may determine the exchange is an unlinked exchange by analyzing the user's transaction history from a to identify transactions associated with the first merchant and sending a query to the third-party computing system 150 with details of the identified transactions (e.g., merchant name, transaction ID, date, amount, etc.) and user data (e.g., user's name, account ID, etc.), and the third-party computing system 150 may perform a database search to identify any user accounts linked to these transaction details. If the third-party computing system 150 responds with data indicating that no linked accounts exist for the provided transaction details, the identification system 112 may determine that the exchange is unlinked. In another example, the identification system 112 may cross-reference the user's transaction details with linked account records stored in the provider's database 120 or account dataset 124, and if no matching linked accounts are found in these datasets, the identification system 112 may determine that the exchange is unlinked.

The generation system 114 of the provider exchange system 110 may generate one or more actionable elements (e.g., interface items, such as content fields, buttons, check-boxes, etc.) corresponding with the first unlinked exchange. For example, after determining the at least one first exchange is unlinked, the generation system 114 may receive exchange or account data related to the at least one first exchange (e.g., data field indicating the exchange is unlinked) and/or corresponding to the user, the provider, and/or the first merchant, and the generation system 114 may incorporate a portion of the data into one or more actionable elements for displaying to the user. For example, the generation system 114 may generate text (e.g., linked or unlinked account text such as “linked” or “unlinked”) for displaying alongside content or user-input features corresponding to the exchange (e.g., content item including a transaction date or other exchange history data) via a GUI provided by application 142. In another example, the generation system 114 may generate one or more actionable elements corresponding with linking of the provider account of the user with the first merchant. In some arrangements, the generation system 114 may further provide, to a device (e.g., mobile device or user device 140) of the user, the one or more actionable elements (e.g., “link account” button, “accounts+” button, etc.) to a graphical user interface (GUI) of an application (e.g., application 142) of the provider. The user may select one or more of the actionable elements to perform various tasks and/or processes, such as linking exchanges and accounts, linking merchant accounts of a user with the provider account of the user, and for various other purposes as further described herein.

In some arrangements, the selection system 116 of the provider exchange system 110 may receive a selection of the one or more actionable elements. For example, in response to a user selecting one or more of the actionable elements (e.g., pressing a “link accounts” or “A+” button), the selection system 116 may receive the selection corresponding with a first request to link the provider account of the user with the first merchant. In another example, the selection system 116 may receive the selection corresponding with the first request to register the new first account of the user with the first merchant (e.g., by a user selecting an “add new accounts” or “A+” button). Further, the selection system 116 may extract data corresponding to the selection (e.g., exchange data or parameters, merchant data, merchant parameters, etc.) and/or perform various additional processes or tasks depending on the selection of the one or more actionable elements received and analyzed by the selection system 116.

In some arrangements, the linking system 118 of the provider exchange system 110 may establish a data communications link with a merchant computing system of the first merchant (a third party of the herein described third parties). For example, the data communications link may include a secure network, channel, or link for communicating, transmitting, or receiving exchange and/or account information between various components of FIG. 1 (e.g., user device 140, provider exchange system 110, identification system 112, generation system 114, etc.). Further, the linking system 118 may communicate with merchant computing systems or other third party computing systems 150 via an interconnected network (e.g., cloud-based network or server). In some arrangements, the linking system 118 may facilitate a user session (e.g., user login session or user account authorization session) between the user device 140 and the third party computing system 150 by authenticating a user's login information and further transmitting and receiving secure communications via the network 130 for a period during which the user's login information remains authenticated. The linking system 118 may further link the provider account of the user with the first account or the new first account of the user (e.g., a user's account with a first merchant of a group of multiple merchants). In some arrangements, the linking system 118 may use an authentication protocol (e.g., OAuth 2.0 authentication protocol) for linking user accounts with a merchant and user accounts with a provider. The process of linking accounts and authentication is described in greater detail below regarding FIG. 2. In some arrangements, the generation system 114 may further update content of the one or more actionable elements of the GUI indicating a successful linking of the first account or the first new account. For example, based on merchant data, user data, provider data, account data, or any other information received from the linking system 118 (e.g., in response to linking an existing account or creating and linking a new account), the generation system 114 may modify, adjust, or create various content items and/or actionable elements to display a successful linking (e.g., “Linked,” “Success,” etc.) to a user via a graphical user interface.

Referring now to FIG. 2, a flowchart for a method that may be implemented or performed by one or more components/systems of FIG. 1 is shown, according to some arrangements. At least provider exchange system 110 of FIG. 1 can be configured to perform method 200. In some arrangements, the steps or blocks of method 200 can be executed sequentially or in parallel (e.g., block 220 and 230 can be performed in parallel. It should be understood that in other embodiments, the steps may be performed in another order, combined, and/or additional modifications implemented, such as the deletion of one or more steps and/or the addition of one or more steps.

As an overview, in method 200, provider exchange system 110 can identify an exchange at block 210. At block 220, the provider exchange system 110 can determine the exchange is an unlinked exchange (e.g., an exchange between the user and a merchant, where the user's merchant account with the merchant is not connected or linked with the user's provider account with the provider). At block 230, user device 140 or provider institution application 142 can generate one or more actionable elements. At block 240, the user device 140 or provider institution application 142 can provide the actionable elements to a GUI. At block 250, the user device 140 or provider institution application 142 can receive a selection of the actionable elements. At block 260, the provider exchange system 110 can establish a data communications link (e.g., with third party computing system 150). At block 260, the provider exchange system 110 can link a provider account. At block 270, the user device 140 or provider institution application 142 can update content of the actionable elements.

At block 210, the one or more processing circuits and, particularly, the provider exchange system 110, can identify an exchange. In some arrangements, at block 210, the provider exchange system 110 can identify at least one first exchange between a user and a first merchant based on exchange history data of the user. For example, identifying may include a provider exchange system 110 determining or identifying a new exchange associated with a user account with the provider (also referred to as a provider account or provider user account) by receiving data regarding the new exchange (e.g., from third party computing system 150 via the network 130) or by querying a database storing exchange and/or account data (e.g., database 120). In another example, identifying may include the provider exchange system 110 processing or facilitate a new exchange (e.g., between a user and a first merchant) and further receiving data corresponding to the new exchange (e.g., exchange date, exchange amount, etc.).

The identifying may include the provider exchange system 110 executing an algorithm, such as a machine learning model (e.g., a neural network trained on historical transaction data), or a rules-based system to match exchange data, parameters, and/or attributes (e.g., date, amount, merchant ID) with user account records (e.g., exchange history data). In some arrangements, the one or more processing circuits may identify the at least one first exchange that is linked to a provider account of the user with a provider. For example, provider exchange system 110 may compare provider data (e.g., exchange history data, account data) corresponding to an exchange to determine the provider facilitated the exchange between the user and the first merchant. In another example, identifying the at least one first exchange linked to the provider account of the user with the provider may include analyzing transaction/exchange data and correlating the exchange data with account linkage criteria defined by the provider's system (e.g., matching transaction timestamps, verifying merchant IDs, cross-referencing user identifiers, validating transaction amounts) by the provider exchange system 110. The provider account of the user may include a digital profile containing unique identifiers and account attributes managed, synchronized, or linked by the provider's data systems (e.g., user ID, transaction logs, account settings, authentication tokens, access codes, encryption keys, etc.).

In some arrangements, the one or more processing circuits, and particularly, the provider exchange system 110, can determine the first merchant corresponds to an exchange rewards system enrolled with the provider. For example, an exchange rewards program may include a merchant system where users can earn points, discounts, or other benefits from transactions with the merchant providing the exchange rewards program. In one example, the exchange rewards program is enrolled with the provider, meaning that the first merchant is part of a group of partnered merchants whose rewards are eligible to be recognized and tracked by the provider exchange system 110. As used herein, determining enrollment may not refer to the actual linking of user accounts (e.g., linking a user's merchant account and/or associated exchange rewards program with a provider account), but instead refers to the provider exchange system 110 determining that the merchant's rewards program is eligible for provider management and/or further linking. For example, the provider exchange system 110 can determine that the exchange rewards program is compatible with the provider's system, meets various provider requirements for linked accounts, and/or is associated with a partnered merchant of a group of partnered or participating merchants agreeing that the provider can manage the participating merchants'exchange rewards programs. For example, the provider exchange system 110 may query the merchant's system (e.g., third party computing system 150) via an API to confirm the merchant's enrollment status. The third party computing system may transmit a response to the API call including data such as an enrollment ID, program terms, and reward structures, indicating the merchant's participation in the program, and the provider exchange system 110 can use the returned information to flag transactions with the merchant as eligible for rewards tracking (e.g., distinct from a process for linking a user's merchant account associated with the exchange rewards program). In another example, the provider exchange system 110 may access a centralized directory of partnered or participating merchants (e.g., maintained in database 120) including merchant information such as merchant IDs (e.g., an identifier of the first merchant), enrollment statuses (e.g., an agreement of the first merchant to participate with the provider), and exchange reward program details (e.g., conversion rates, earning rates, etc.). The provider exchange system 110 can cross-reference transaction data with the information in this directory to verify a merchant's enrollment. For example, if a user makes a purchase at a merchant, the provider exchange system 110 can check the merchant ID against the directory, and if the merchant is listed as enrolled, the provider exchange system 110 can identify or flag the transaction for rewards tracking and further linking opportunities.

At block 220, the one or more processing circuits and, particularly the provider exchange system 110, can determine the exchange is an unlinked exchange. In some arrangements, at block 220, in response to identifying at least one first exchange, the one or more processing circuits can determine the at least one first exchange is a first unlinked exchange of the provider account of the user and the first merchant. As used herein, an “unlinked” exchange refers to an exchange between the user and a merchant, where the user's merchant account with the merchant is not connected or linked with the user's provider account with the provider. In one example, the provider exchange system 110 may determine the exchange is an unlinked exchange by analyzing the user's transaction history to identify transactions associated with the first merchant and sending a query to the third-party computing system 150 associated with the first merchant with details of the identified transactions (e.g., merchant name, transaction ID, date, amount, etc.) and user data (e.g., user's name, account ID, etc.). In response, the third-party computing system 150 may perform a database search to identify any user accounts linked to these transaction details. Continuing this example, if the third-party computing system 150 responds with data indicating that no linked accounts exist corresponding with the provided transaction details, the provider exchange system 110 may determine that the exchange is unlinked. In another example, the identification system 112 may extract entity identifiers (e.g., merchant names, merchant identification numbers, etc.) by analyzing a user's linked account records stored in the provider's database 120 to search for matching records corresponding with linked accounts of the user, and if no matching linked accounts are found in these datasets, the provider exchange system 110 may determine that the exchange is unlinked. For example, determining may include the provider exchange system 110 analyzing the exchange history data and account data to check for an existing link (e.g., previous user authentication, data corresponding to successful linking of an account, etc.) between the provider account and the merchant account. If no link is found, the exchange can be classified as unlinked by the provider exchange system 110. In another example, the provider exchange system 110 may receive a confirmation from a merchant computing system indicating that the exchange has not been previously linked to the provider account to identify the unlinked exchange.

At block 230, the one or more processing circuits, and particularly, the user device 140, can generate one or more actionable elements. In some arrangements, at block 230, the one or more processing circuits can generate one or more actionable elements corresponding with the first unlinked exchange. For example, the actionable elements may be presented as interactive features (e.g., buttons) on a GUI executing on user device 140 and include content indicating that the interactive features can be interacted with to link or unlink third-party information to the user provider account based on analyzing the exchange history of the user. The actionable elements may be dropdown menus, checkboxes, input fields, and/or other user-selectable elements that allow the user to provide additional information or preferences related to linking accounts (e.g., selecting account types, specifying transaction thresholds, entering multi-factor authentication codes). In some embodiments, the one or more actionable elements may be generated and provided by the provider institution application 142. In another embodiment, at least some of the one or more actionable elements may be generated and provided by the provider exchange system 110. In some arrangements, at least one of the one or more actionable elements corresponds with linking a first account of the user with the first merchant or registering a new first account of the user with the first merchant (e.g., the first merchant being one of a group of multiple merchants with unlinked merchant accounts). For example, actionable elements may include labels such as “Link Account,” “Accounts+,” “Link New Account,” “Add Account,” “A+,” “Link Exchange,” “Unlink Exchange,” and/or other labels to facilitate users linking or synchronizing user data or account linkages directly from the provider mobile application 142. In an example, generating the actionable elements may include identifying appropriate GUI components for presenting content based on the detected unlinked exchanges, creating corresponding interactive elements in a GUI framework, and/or updating a layout of the GUI to incorporate the interactive or actionable elements. In some arrangements, generating may include generating non-interactable elements (referred to as informational content items), which may include various information such as exchange history data or account data for presenting to the user on the graphical user interface. Further, the generating may include the provider exchange system 110 and/or the provider application 142 creating dynamic UI tooltips or pop-up messages that provide information, assistance, or guidance to the user during the linking process (e.g., illustrative benefits of linking or synchronizing accounts, offering tips on secure account management, displaying validation results of inputted data, etc.).

At block 240, the one or more processing circuits, and particularly, the application 142, can provide the actionable elements to or via a GUI. In some arrangements, at block 240, the application 142 can generate the one or more actionable elements to a graphical user interface (GUI) that is provided via the provider mobile application 142. For example, the providing may include the user device 140 using a framework to insert the actionable elements into predefined slots within the GUI layout (e.g., using cross-platform mobile development frameworks, declarative UI frameworks, etc.). In another example, the one or more processing circuits may update the GUI elements asynchronously via API calls (e.g., using third party or merchant APIs, etc.) and facilitate interface responsiveness during updates. Further, providing may include employing differential rendering techniques to update only updated or changed elements of the GUI (e.g., virtual DOM diffing, incremental DOM updates, etc.). For example, the actionable elements may be rendered as part of a main interface of a GUI of the provider mobile application 142, and the provider mobile application 142 may utilize existing GUI frameworks to dynamically insert the elements into the appropriate locations within the provider application 142. In another example, the actionable elements can be delivered through a background update process, where the GUI is refreshed to display the new elements without the user restarting the application to provide exchange and/or account information or actions available in real-time (e.g., instantaneously or substantially instantaneously).

At block 250, the one or more processing circuits, and particularly, the application 142, can receive a selection of the actionable elements. For example, the application 142 can receive the selection and provide the selection to the provider exchange system 110. In another example, the application 142 can be a web-based interface, the provider exchange system 110 may receive the selection via the web-based interface through the network 130. For example, receiving a selection of the actionable elements may include detecting a user's interaction with the interactive buttons on the GUI (e.g., a tap or click on a “Link Account” button, swiping on a touchscreen to select a drop-down item, scanning a scannable code, etc.). In some arrangements, at block 250, the one or more processing circuits can receive a selection of the one or more actionable elements corresponding with a request to link the merchant account of the user to the provider account or a request to register a new merchant account for the user with the merchant. For example, the user may select a “Link Account” button to link their existing provider account with the merchant and the user device 140 (when the user is interacting with the provider exchange system 110 via a web-based interface) or the provider mobile application 142 may initiate the linking process. Alternatively, the user may select the “Link New Account” button and the user device or application may create and register a new account with the first merchant. In another example, the application 142 can receive a selection by processing gesture-based interactions (e.g., pinch-to-zoom, long press to activate a contextual menu, etc.).

At block 260, the one or more processing circuits can establish a data communications link between the provider exchange system 110 and third party computing system 150. In one example, the data communications link may be generated by the provider exchange system 110 initiating a TLS or SSL handshake with the third-party computing system 150 or by performing mutual authentication through the exchange of security certificates. In one example, a data communications link includes a secure connection using technologies such as Transport Layer Security (TLS), Secure Sockets Layer (SSL), or Hypertext Transfer Protocol Secure (HTTPS) (e.g., using network 130 of FIG. 1) between the provider exchange system and a merchant computing system. In another example, a data communications link could be an API integration to facilitate data transfer between the provider mobile application 142 and a third-party computing system 150 (i.e., a backend system of the merchant). In some arrangements, block 260 may include the one or more processing circuits establishing a data communications link with a merchant computing system of a merchant. For example, a user device (e.g., user device 142 of FIG. 1) may facilitate the exchanging of authentication tokens between the provider application and the merchant computing system (e.g., third party computing system 150 of FIG. 1) to provide a secure communication channel for authenticating and/or for linking accounts (e.g., using a standard authentication procedure, as described in greater detail below). Further, establishing a data communications link may involve using secure web services protocols (e.g., SOAP, REST, etc.) to facilitate encrypted data exchange between an application (e.g., provider mobile application 142 of FIG. 1) and the computing system of the merchant (e.g., third party computing system 150 of FIG. 1). In another example, establishing a data communications link may include setting up mutual TLS (mTLS) for client and server authentication.

At block 270, the one or more processing circuits can link a provider account of the user that is maintained by the provider exchange system 110. In some arrangements, at block 270, the provider exchange system 110 can link the provider account of the user with the account or the new account of the user with the merchant by updating database 120 of the provider to reflect an association between the user's provider account and the merchant account (e.g., to facilitate synchronized data exchanges and reward eligibility tracking). Further, linking may include the provider exchange system 110 synchronizing the user's profile attributes between the provider and the merchant systems (e.g., using data replication techniques or other data duplication methods). In another example, the provider exchange system 110 may link the provider account with the merchant account by associating metadata of the user's transactions across both provider and merchant systems (e.g., utilizing federated identity management to map or align user identities to accounts and/or exchanges).

In some arrangements, the provider exchange system 110 may further provide, via the data communications link with the merchant computing system (e.g., third party computing system 150), a login interface of the merchant in a viewport (e.g., viewable window) of the provider mobile application 142. For example, the login interface may be embedded within the provider mobile application 142, and the provider mobile application 142 can receive user input (e.g., account credentials) from the login interface in response to the user interacting with the user device 140. In another example, the application 142 can provide or display the login interface as a pop-up or other window within the provider application 142 and be configured to collect the user's login information for the merchant account. Further, the application 142 can integrate a single sign-on (SSO) feature to authenticate a user account (e.g., log in) using user credentials from another service (e.g., OAuth or SAML-based authentication). In another example, the provider application 142 can provide the login interface including a two-factor authentication (2FA) mechanism (e.g., via a user entering a code received via SMS or an authentication app).

In some arrangements, in response to the user inputting a login credential using the login user interface, the one or more processing circuits, and particularly, the provider exchange system 110, can receive, via the data communications link, an authorization code for accessing the account of the user with the merchant (at a third party computing system 150) or the new account of the user with the merchant. Thus, the authorization code is a code used to access the third-party account from within the provider application 142. The authorization code may include at least one of a QR code, a bar code, a numerical and/or character code, or biometric identifier and be used by the provider exchange system 110 to identify and authenticate a user login session. In another example, the authorization code may include a limited-use (e.g., one-time, two-time, etc.) password (e.g., OTP) that is valid for a short duration and can be used a predefined number of times (e.g., once for an OTP). Further, the provider exchange system 110 can receive the authorization code responsive to the merchant computing system (e.g., third party computing system 150) validating the authorization code and generating an access token. Further, validating and generating the access token may involve the merchant computing system or provider exchange system 110 cross-referencing the authorization code with a database of issued codes to verify the code is valid and/or creating a session token to grant temporary access to an account of the user. For example, receiving may include the provider exchange system 110 transmitting the authorization code to the merchant computing system, and the merchant computing system may further validate the authorization code and generate and output the access token (e.g., in response to successful validation or verification).

In some arrangements, the one or more processing circuits, and particularly, the provider exchange system 110, can further receive, via the data communications link, account data and exchange data. For example, the provider exchange system can receive account data including details received via a network (e.g., network 130 of FIG. 1) such as the user's profile information, linked accounts, and account settings, while exchange data may include transaction history, reward points, and current offers. In some arrangements, receiving may include the provider exchange system 110 receiving the account data and exchange data in exchange for providing the access token to the merchant computing system (e.g., third party computing system 150). For example, the provider exchange system 110 can provide the access token to the third party computing system 150 to receive updated account balances, recent transaction details, and/or available reward points. In another example, the provider exchange system 110 may receive account data including transaction preferences or security settings, and exchange data including details of recent promotional transactions or loyalty points earned. Further, the provider exchange system 110 may process a user's account data to personalize a user interface and/or security protocols and similarly process exchange data to update rewards balances, update account status, and/or provide offers to a user (e.g., rewards offers, linking offers, etc.).

At block 280, the one or more processing circuits, and particularly, the application 142 (in one embodiment), can update content of the actionable elements. In some arrangements, at block 280, the application 142 can update content of the one or more actionable elements of the GUI indicating a successful linking of the first account or the new first account. For example, the updating may include the application 142 modifying content items, actionable elements, content of actionable elements, and/or various other GUI elements (e.g., images, text fields, buttons, drop-down lists, etc.) displayed on user device 140 executing the provider application 142 to indicate the user account with the merchant is “linked” or “unlinked” to the provider account of the user. In another example, updating may include the application 142 displaying the text “Linked” in a content item and/or actionable element alongside an exchange corresponding to the merchant (e.g., first merchant). Further, updating may include the user device 140 or application 142 dynamically refreshing (e.g., using AJAX calls, etc.) content items or actionable elements of a GUI to reflect a new status corresponding to account linkage or disconnection of one or more user accounts. In another example, updating may include the application 142 generating notifications or alerts (e.g., push notifications, in-app messages) to indicate a successful linking and/or subsequent changes to user accounts or to exchange data.

In some arrangements, the provider exchange system 110 can analyze a user's transaction history to identify exchanges with merchants and determine whether these exchanges involve accounts with merchants that are unlinked with the user's provider account, as well as if there are redeemable rewards associated with the merchant accounts, and further present such unlinked merchant accounts and/or redeemable rewards to the user via application 142. For example, the provider exchange system 110 can process provider data including user's credit card statements, transfer history, and transaction logs to identify merchant names or identifiers. That is, the provider exchange system 110 can use algorithms to scan and extract transaction details such as merchant names, transaction IDs, dates, and amounts from a user's exchange history. For example, the provider exchange system can cross-reference the extracted data (e.g., identified merchant names) with a database of partnered merchants to flag transactions that may be associated with an unlinked merchant account, and for each flagged transaction, the provider exchange system 110 can query internal records to determine if the user's account with the merchant is already linked (e.g., searching through the provider's database 120 or account dataset 124 for a linked account corresponding with the merchant name or identifier).

In another example, the provider exchange system 110 can identify unlinked accounts by communicating with third party computing system 150 over the network 130. That is, the provider exchange system 110 can send transaction details and user data (e.g., a merchant name or identifier) and further data or instructions (e.g., an endpoint call) to cause the third party computing system 150 to scan internal merchant records and provide a response corresponding to whether the user's provider account is linked or otherwise stored in a manner accessible to third party computing system 150 (e.g., in a merchant database or otherwise available to the third party computing system 150 via communications over network 130). If the third party computing system 150 provides a response indicating no linked accounts are found, the provider exchange system 110 can confirm the account as unlinked and provide this information to the user via a GUI of application 142.

If the third party computing system 150 provides a response indicating that the user's merchant account is linked to the provider on the merchant's bank end, the provider exchange system 110 can assess whether there are any redeemable rewards by querying the merchant's rewards system (e.g., via an API call to third party computing system 150 via the network 130) or checking pre-stored rewards information (e.g., stored in database 120). For example, the provider exchange system 110 can send an API request to the third-party computing system 150 to retrieve the current points balance in the user's merchant rewards account. If the balance meets the criteria for redemption, the provider exchange system 110 can notify the user of such rewards via the application 142 on the user device 140. In another example, the provider exchange system 110 can query the third party computing system 150 to provide data from merchant's rewards system associated with the user's merchant account, and the provider exchange system 110 can process this data and identify if there are any accrued rewards points, available discount vouchers, or promotional codes associated with the user's merchant account. Further, the application 142 can provide or communicate the information regarding, e.g., the accrued rewards points, to the user through a GUI, which can prompt or encourage the user to utilize the discounts and prevent wasting rewards points. In another example, the provider exchange system 110 can request information about the user's reward tier status from the third-party computing system 150, and if the user qualifies for a higher reward tier (e.g., Gold or Platinum), the provider exchange system 110 can informs the user of the new benefits associated with their status (e.g., unused rewards points accumulated through advancement through the tiers). In one example, the provider exchange system 110 can check the expiration dates of rewards points or benefits received from or determined by accessing the merchant's rewards data, and if any rewards are nearing expiration, the provider exchange system 110 can alert the user to the expiring rewards via the application 142 and encourage the user to redeem the points before expiration.

In some examples, the provider exchange system 110 may identify multiple unlinked user accounts (e.g., user accounts with multiple merchants that are unlinked to the user's provider account). If multiple (e.g., one or more unlinked accounts are found), the provider exchange system 110 can generate or compile a list of the unlinked accounts and associated rewards and present this information to the user via the application 142 executing on the user device 140. In one example, the provider exchange system 110 can provide data and/or instructions to the application 142 to generate prompts or actionable elements within the GUI to indicate the list of unlinked user accounts or to prompt the user to link such accounts and/or redeem corresponding rewards (e.g., via a message such as, “You have unclaimed rewards with this merchant. Link your account to redeem them”).

In some arrangements, the one or more processing circuits, and particular, the provider exchange system 110, can further identify at least one second exchange linked to the provider account of the user. For example, identifying the at least one second exchange can include the provider exchange system 110 analyzing exchange history data (e.g., data of past transactions or exchanges) and/or account data (e.g., data of linked or unlinked accounts) to detect additional exchanges associated with the provider account for linking (e.g., corresponding to additional merchants such as a second merchant). In another example, the provider exchange system 110 may identify the second exchange based on received data including one or more new exchange(s) (e.g., occurring in the present) and/or additional exchange(s) (e.g., past unlinked exchanges/accounts, etc.). In some arrangements, the at least one second exchange is a second unlinked exchange of the provider account between a second merchant and the user. For example, a second unlinked exchange may refer to a transaction or interaction with a second merchant that has not yet been associated with the user's provider account, indicating that the exchange data has not been synchronized or linked with the provider system. In another example, the provider exchange system 110 may identify the second unlinked exchange that has not yet been linked to the provider account by cross-referencing transaction records and account data.

In some arrangements, the provider exchange system 110 can further generate one or more content items corresponding to one or more unlinked user accounts. For example, a content item may be a visual component on the GUI (e.g., a card or banner) that presents information related to the unlinked user account (e.g., merchant name, exchange details, indicators of linked or unlinked accounts, etc.). Further, generating may include provider exchange system 110 creating interactive elements or informational messages within the GUI to notify the user of unlinked accounts (e.g., by generating content items, by generating actionable elements, or by updating content of content items or actionable elements to indicate an “unlinked” user account). In some arrangements, the one or more content items may correspond to one or more unlinked user accounts based on the first unlinked exchange and the second unlinked exchange. For example, the GUI of application 142 may display a list of unlinked accounts, each with actionable buttons for linking and content items to display an “unlinked” status of the account or exchange. In another example, content items may include graphical indicators (e.g., colors, patterns, icons, badges, etc.) to display various user data and/or account information (e.g., highlighting unlinked accounts, providing total numbers of unlinked accounts with exchanges on the provider's system, etc.), or other data structures/formats (e.g., tables, charts, graphics, etc.) listing linked or unlinked accounts, exchanges, merchant data, and/or provider data via the application 142. In some arrangements, the application 142 can further provide the one or more content items corresponding to the one or more unlinked user accounts to the GUI in a viewport of the provider mobile application. In an example, providing may include generating dynamic pop-ups, embedding interactive elements within the GUI, or creating expandable sections that reveal additional information or actions (e.g., sensitive account data such as usernames or passwords). Further, the application 142 may integrate content items or actionable elements into a provider interface and may display and provide real-time updates and options for the user to synchronize or link user data or various merchant accounts (e.g., accounts of a user and first merchant, second merchant, third merchant, etc.). In another example, the application 142 can display the content items and/or actionable elements as notifications or alerts prompting the user to take action to cause linking of user accounts.

In some arrangements, the one or more processing circuits, and particularly, the application 142, can further update content of the one or more actionable elements prompting the user to select the first merchant or the second merchant for linking. For example, updating may include the application 142 updating the GUI to include specific options for each merchant, such as “Link Account with First Merchant” or “Link Account with Second Merchant,” and the user may choose which account to link by interacting with the actionable elements. In another example, prompting may include the application 142 displaying or providing a pop-up window including interactive elements to facilitate a user login or authentication session. For example, a user login session may include the application 142 receiving a predefined time period for an authentication session and/or may include various processes for a user to enter account information or credentials via the application 142, including a traditional or standard login session (e.g., the user entering a username and passcode into input fields for submission), a social login (e.g., the user logging in using credentials from a third-party service), a session involving two-factor authentication (e.g., the user entering a username and passcode followed by a verification code sent to their mobile device or email), biometric authentication (e.g., the user using fingerprint or facial recognition to authenticate), single sign-on (SSO) (e.g., the user logging in once through an identity provider to gain access to multiple related applications without needing to log in again), and more.

In some arrangements, the one or more processing circuits, and particularly, the provider exchange system 110 can receive a first selection of the one or more actionable elements corresponding with a second request to link the first account of the user with the first merchant or register the new first account of the user with the first merchant or a second selection of the one or more actionable elements corresponding with a third request to link a second account of the user with the second merchant or register a new second account of the user with the second merchant. For example, the user may select an actionable element indicating a request to link an existing (e.g., previously created) account with the first merchant, and the provider exchange system 110 may identify stored account credentials or other data corresponding to the existing account to determine the account is previously-created and unlinked. In another example, the user may choose to register a new account with the second merchant and provide a username, passcode, and/or various other user data (e.g., contact information such as email, demographics such as age, etc.) to a merchant computing system to create new account of the user with the merchant (e.g., initiating an account creation interface or process for a user), which may be facilitated by the provider exchange system 110. In some arrangements, the provider exchange system 110 can further link the provider account of the user with the first account or the new first account of the user with the first merchant or the provider account of the user with the second account or the new second account of the user with the second merchant. For example, the user may select one or more actionable elements corresponding to (or indicating via content) a request to link an existing user account with the first merchant, or the user may choose to register a new account with the second merchant, prompting the provider exchange system 110 to initiate a registration and linking process (e.g., using OAuth authentication or other standard authentication frameworks). In another example, the user may select an actionable element to link an additional account with another merchant, such as a third account with a third merchant, and, in response, the provider exchange system 110 can process an additional linking request and update the provider account based on the request. In some arrangements, any number of merchants may be included in an account linking or synchronization list provided to the user (e.g., via content of a GUI presented on application 142). In another example, the provider exchange system 110 may receive data including a list of unlinked accounts and may transmit the list to the user for the user (e.g., for the user to determine whether to link one or more of the unlinked accounts with the provider account).

In some arrangements, the one or more processing circuits, and particularly, the provider exchange system 110, can further receive, via the data communications link, at least one second exchange between the user and a first merchant. For example, the provider exchange system 110 may receive transaction/exchange data indicating a recent, new, or additional exchange between the user and the first merchant. In another example, receiving may include the provider exchange system 110 analyzing exchange or account data to determine an additional or new exchange or transaction (e.g., recent payment, future/scheduled payment, etc.). In some arrangements, the provider exchange system 110 can further determine that the second merchant corresponds to a second exchange rewards system enrolled with the provider. In this example, the second exchange rewards system is enrolled with the provider, meaning that the second merchant is part of a group of partnered merchants whose rewards are eligible to be recognized and tracked by the provider exchange system 110 (e.g., distinct from accounts being linked as further described herein). For example, determining the exchange rewards system associated with the merchant (e.g., associated with the second merchant) is enrolled can include the provider exchange system 110 querying a computing system associated with the second merchant via an API, receiving data such as an enrollment ID, program terms, and reward structures, and processing or analyzing the received data to confirm the enrollment status of the associated exchange rewards program.

In some arrangements, the provider exchange system 110 can further determine the at least one second exchange is linked to the provider account of the user with the provider. For example, determining may include the provider exchange system 110 identifying the first account of the user with the first merchant or the new first account of the user with the first merchant. In another example, determining may include the provider exchange system 110 processing and/or querying stored account data to detect account data corresponding to the first account or the first new account. In some arrangements, the application 142 can update the content of the one or more actionable elements of the GUI indicating a link between the first account of the user or new first account of the user with first merchant, the at least one second exchange, and the provider account of the user with the provider. For example, the application 142 may update a GUI to display updated statuses next to each exchange indicating whether the exchanges are linked or unlinked, along with options for user interaction with corresponding links (e.g., including buttons for linking or unlinking accounts/exchanges). In another example, the application 142 and/or provider exchange system 110 may generate or create content items and/or actionable elements corresponding to the links (e.g., linked account status) and provide these items/elements to the GUI. In some arrangements, the application 142 can further present the content including merchant data and account data to the GUI in a viewport (e.g., viewable window) of the provider mobile application 142. For example, the application 142 can present merchant data including data such as a merchant ID, merchant name, transaction timestamps, partnership/rewards information, and/or various other vendor-or merchant-related information. In another example, the application 142 can present account data including user profile information, account balances, linked account statuses, and other account data (e.g., numbers of linked accounts, method of authentication, etc.). For example, the application 142 may update content displayed on a GUI to include an updated exchange history including the second exchange and/or various other information (e.g., current reward balances, account settings, balances, other exchanges, etc.).

In some arrangements, in response to linking of the first account or the new first account, the one or more processing circuits, and particularly, the provider exchange system 110, can provide exchange rewards to the user. For example, the provider exchange system 110 may provide exchange rewards including cashback, points, discounts, promotional offers, or loyalty credits, which may correspond with one or more exchanges of user with various merchants facilitated by a provider application. In some arrangements, the provider exchange system 110 can further identify an exchange amount of the at least one first exchange (e.g., of multiple exchanges) in providing the exchange rewards to the user. For example, identifying may include the provider exchange system 110 processing or analyzing a transaction amount (e.g., exchange amount) of the first exchange to calculate the corresponding reward. In another example, identifying may include the provider exchange system 110 evaluating the frequency of transactions within a specified period to determine eligibility for a reward. In some arrangements, the provider exchange system 110 can further receive, over the data communications link, one or more merchant parameters. For example, the provider exchange system 110 can receive merchant parameters including reward rates, promotional multipliers, merchant-specific offers, transaction thresholds, eligibility criteria, and various other parameters and/or criteria related to exchange rewards. In another example, the provider exchange system 110 can receive merchant parameters including tiered reward levels, seasonal bonus offers, redemption restrictions, or expiration dates. In some arrangements, the provider exchange system 110 can further determine an exchange reward amount based on the exchange amount and at least one of the one or more merchant parameters. For example, the provider exchange system 110 may calculate the exchange reward amount by applying a reward rate (e.g., 2% cashback) to the exchange/transaction amount of the first exchange (e.g., providing 2% of the exchange amount back to the user as exchange rewards based on a linked account). In another example, the provider exchange system 110 may calculate the exchange reward amount by applying a combination of promotional multipliers and reward rates based on user spending patterns (e.g., offering higher rewards for frequent purchasers). In some arrangements, the application 142 can generate one or more content items corresponding to the exchange reward amount. For example, the application 142 may create a digital receipt showing the reward amount earned from the exchange (e.g., “You have earned 60 points,” etc.). Further, generating may include the application 142 creating a visual representation of the reward amount (e.g., a progress bar or graphical icon) for display using the GUI. In some arrangements, the application 142 can provide the one or more content items corresponding to the exchange reward amount to the GUI in a viewport (e.g., viewable window) of the provider mobile application. For example, the application 142 may display content items in a rewards section (e.g., rewards page) of GUI presented by the provider application 142 and display details of earned rewards and current reward balances to the user. In another example, the provider application 142 can update content items dynamically to reflect real-time reward accumulation and redemption options (e.g., points totals, multipliers, changes participating/partner merchants, etc.).

In some arrangements, the one or more processing circuits, and particularly, the provider exchange system 110 can further provide exchange rewards to the user in response to linking of the first account or the new first account. In some arrangements, the provider exchange system 110 can access the first account of the user with the first merchant or the first new account of the user with the first merchant via the data communications link. For example, accessing may include the provider exchange system 110 establishing a secure connection (e.g., a user authentication session, etc.) with a merchant computing system of a merchant (e.g., third party computing system 150) to access various information related to exchange rewards (e.g., to access account details, transaction history, and reward eligibility criteria) by initiating a handshake to authenticate the user and encrypt the communication between the merchant and provider exchange systems, querying the merchant's database for the required information, and retrieving the relevant data securely during the encrypted session. In another example, accessing may include the provider exchange system 110 using an API call to retrieve encrypted reward information from the merchant's server. In some arrangements, the provider exchange system 110 can further retrieve an exchange reward value from the first account or the first new account. For example, an exchange reward value may include or be an indication of an accumulated points amount or other types of rewards earned from past transactions. In another example, the provider exchange system 110 can determine an exchange reward amount based on a combination of user-specific activity metrics, such as average transaction value and transaction frequency (e.g., higher rewards for users with frequent high-value transactions), and various other criteria corresponding to the reward program structure. In some arrangements, the application 142 can generate one or more content items corresponding to the exchange reward value. For example, the application 142 may create actionable elements and/or content items to display the exchange reward amount to the user. In another example, generating may include the application 142 creating or consolidating reward information (e.g., points earned, partners for redeeming, etc.) into elements or icons for display to the user via a GUI (e.g., as one or more content items, as content of actionable elements, etc.). In some arrangements, the application 142 can provide the one or more content items corresponding to the exchange reward amount to the GUI in a viewport of the provider mobile application 142. For example, the one or more processing circuits may cause a graphical user interface executed by a provider application 142 of the provider to display available rewards to a user corresponding to various exchanges and/or linked accounts associated with the various exchanges. In another example, generating may include the application 142 creating visual indicators such as progress bars or reward status icons within the GUI to reflect the current reward points and potential uses (e.g., listing partner entities, conversion rates, points totals, etc.).

In some arrangements, the one or more processing circuits, and particularly, the provider exchange system 110, can further generate a first scannable code of the first account or the new first account of the user with the first merchant. For example, the provider exchange system 110 can generate a first scannable code including a QR code (or quick-response code), barcode, numerical code, or any other type of scannable code that can be read by various scanning devices (e.g., other two-dimensional matrix codes, micro QR codes, Aztec codes, Data Matrix codes, PDF417 codes, or traditional linear barcodes). Further, generating may include the provider exchange system 110 aggregating exchange data, account data, and/or user data, executing a hashing algorithm to create a unique data string, and encoding the unique data string into a QR code, numerical code, or barcode format for scanning. In another example, generating may include the provider exchange system 110 combining user-specific information with a unique session identifier, applying a QR code generation library to produce a scannable image, and/or updating the code/image based on user activity. In some arrangements, the first scannable code is unique to the provider account of the user with the provider. For example, the scannable code may encode specific information that links directly to the user's provider account such that any scan of the scannable code retrieves the relevant account details from the provider's system. In some arrangements, the first scannable code is different from a second scannable code of the first account or new first account of the user of a merchant mobile application of the first merchant. For example, the first scannable code generated by the provider exchange system 110 may contain unique identifiers and encryption keys that are specific to an account management or data synchronization system of the provider and may be distinguishable from codes generated by a merchant computing system (e.g., third party computing system 150) or application of a merchant. In another example, the first scannable code can encode user account information for access or retrieval from or by the provider's system or ecosystem (e.g., in a database or data source), while the second scannable code (e.g., generated by a merchant application or a merchant computing system, or corresponding to a merchant application or computing system, etc.) can include data for merchant-specific transactions (e.g., user spending via merchant platforms, etc.). In some arrangements, in response to receiving the selection of the one or more actionable elements corresponding with the first request to link the first account of the user with the first merchant or register the new first account of the user with the first merchant, the provider exchange system 110 can provide the first scannable code to the GUI of the provider mobile application 142. In some arrangements, the provider exchange system 110 can provide the one or more content items to the GUI in a viewport (e.g., viewable window) of the provider mobile application. For example, the application 142 may display the scannable code alongside other account details in the user's profile section, and the user may access and scan the code to cause the provider exchange system 110 to link accounts, verify transactions, and/or redeem rewards directly through the provider mobile application 142. In another example, the application 142 may update the GUI to display the first scannable code (e.g., as a content item or as content of an actionable item), and the user may interact with the first scannable code (e.g., using a camera of an electronic device, such as a cell phone camera) to cause the provider exchange system 110 perform various tasks related to synchronizing and/or linking accounts or exchanges (e.g., for receiving exchange rewards).

In some arrangements, the one or more processing circuits, and particularly the application 142, can further generate the one or more actionable elements of the GUI based on linked account information. For example, the linked account information can include data of a plurality of merchants including linked user accounts and unlinked user accounts with the provider account of the user associated with the provider exchange system 110. In another example, generating may include the application 142 updating the content of at least one of the one or more actionable elements to indicate an unlinked account of at least one or the plurality of merchants. Further, generating may include the application 142 creating interactive dropdown menus, dynamic checkboxes, or real-time validation prompts that provide users with options to view, manage, and link multiple accounts from different merchants. For example, generating may include the application 142 (e.g., via communications with the provider exchange system 110) retrieving user data, exchange data, or account data, analyzing an account linkage status of the accounts (e.g., linked or unlinked status), and updating various GUI elements to reflect changes in the account linkage status (e.g., highlighting unlinked accounts with a distinct visual indicator, providing tooltips with additional account information, or displaying a summary of rewards associated with linked accounts). In some arrangements, in response to the user interacting with at least one of the one or more actionable elements, the provider mobile application 142 can provide a pop-up message prompting the user to provide account credentials for linking at least one unlinked user account with the provider account. For example, the application 142 can provide a pop-up message displaying fields for entering a username and password, along with a secure authentication method such as a one-time passcode sent to the user's registered email or phone number. Further, prompting may include the application 142 providing or displaying a pop-up message to guide the user through a process to authenticate and link the account. For example, the provider exchange system 110 may utilize the data received in response to the pop-up message for verifying the user's identity through biometric authentication, such as fingerprint or facial recognition, and then confirming the linkage by displaying a success message and updating an account status (e.g., a linked or unlinked status) in the GUI of the provider mobile application 142. In another example, providing may include the provider mobile application 142 presenting a Single Sign-On (SSO) feature for users to authenticate accounts using existing credentials from various platforms.

In some arrangements, the one or more processing circuits, and particularly, the provider exchange system 110, can identify merchant rewards for a user by partnering with various merchants in a rewards transfer program. For example, identifying may include the provider exchange system 110 processing or analyzing the customer's exchange history (e.g., credit card statement, transfer history, transaction history, etc.) to identify exchanges with the partnered merchants. For example, the provider exchange system 110 can analyze a user's transactions, and if transactions with a merchant are found, the provider exchange system 110 may determine if the customer has already linked a user account with the merchant to the provider. If the provider exchange system cannot find a linked account, the one or more processing circuits can prompt the customer with a message for linking (e.g., “Do you have an account with this merchant?—if so, please link”). In some arrangements, the provider exchange system 110 can further compile a list of all or most missing linked accounts with merchants (e.g., online retailers, airlines, restaurants, entertainment companies, etc.) and provide a summary list to the customer (e.g., prompting the customer to select which of the missing accounts to link). In some arrangements, the application 142 may generate actionable elements within the GUI to prompt the user to provide account credentials and/or cause the provider exchange system 110 to link identified unlinked accounts.

Referring now to FIG. 3, block diagram illustrating an example computing system 300 suitable for use in the various arrangements described herein is shown. The computing system 300 may represent provider exchange system 110, database 120, user devices 140, third party computing systems 150, and/or various other example computing systems described herein. FIG. 3 is a block diagram illustrating an example computing system suitable for use in the various arrangements described herein, according to some arrangements. The computing system 300 includes a bus 305 or other communication component for communicating information and a processor 310 coupled to the bus 305 for processing information. The computing system 300 also includes main memory 315, such as a random-access memory (RAM) or other dynamic storage device, coupled to the bus 305 for storing information, and instructions to be executed by the processor 310. Main memory 315 can also be used for storing position information, temporary variables, or other intermediate information during execution of instructions by the processor 310. The computing system 300 may further include a read only memory (ROM) 320 or other static storage device coupled to the bus 305 for storing static information and instructions for the processor 310. A storage device 325, such as a solid-state device, magnetic disk, or optical disk, is coupled to the bus 305 for persistently storing information and instructions.

The computing system 300 may be coupled via the bus 305 to a display 335, such as a liquid crystal display, or active-matrix display, for displaying information to a user. An input device 330, such as a keyboard including alphanumeric and other keys, may be coupled to the bus 305 for communicating information, and command selections to the processor 310. In another arrangement, the input device 330 has a touch screen display 335. The input device 330 can include any type of input device, such as a biometric sensor, a cursor control, such as a mouse, a trackball, or cursor direction keys, for communicating direction information and command selections to the processor 310 and for controlling cursor movement on the display 335.

In some arrangements, the computing system 300 may include a communications adapter 340, such as a networking adapter. Communications adapter 340 may be coupled to bus 305 and may be configured to facilitate communications with a computing or communications network 130 and/or other computing systems. In various illustrative arrangements, any type of networking configuration may be achieved using communications adapter 330, such as wired (e.g., via Ethernet), wireless (e.g., via Wi-Fi, Bluetooth), satellite (e.g., via GPS) pre-configured, ad-hoc, LAN, WAN.

According to various arrangements, certain processes that effectuate illustrative arrangements that are described herein can be achieved by the computing system 300 in response to the processor 310 executing an arrangement of instructions contained in main memory 315. Such instructions can be read into main memory 315 from another computer-readable medium, such as the storage device 325. Execution of the arrangement of instructions contained in main memory 315 causes the computing system 300 to perform the illustrative processes described herein. One or more processors in a multi-processing arrangement may also be employed to execute the instructions contained in main memory 315. In alternative arrangements, hard-wired circuitry may be used in place of or in combination with software instructions to implement illustrative arrangements. Thus, arrangements are not limited to any specific combination of hardware circuitry and software.

Although an example processing system has been described in FIG. 3, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 3 as singular, stand-alone devices, one of ordinary skill in the art will appreciate that, in some arrangements, the computing system 300 may include virtualized systems and/or system resources. For example, in some arrangements, the computing system 300 may be a virtual switch, virtual router, virtual host, virtual server. In various arrangements, computing system 300 may share physical storage, hardware, and other resources with other virtual machines. In some arrangements, virtual resources of the network 130 (e.g., network 130 of FIG. 1) may include cloud computing resources such that a virtual resource may rely on distributed processing across more than one physical processor, distributed memory, etc.

Referring now to FIGS. 4A-4C, example graphical user interfaces depicting an application user interface 400 are shown, according to some arrangements. In general, the application user interface 400 (or “graphical user interface 400,” “GUI 400,” etc.) facilitates synchronization and/or linking of exchanges or accounts between a user, a provider, and one or more merchants. In some arrangements, the graphical user interface 400 is provided by a user device (e.g., mobile device 140 of FIG. 1), via a client or user application and, particularly, the application 142. In other arrangements, the graphical user interface 400 is provided (e.g., by user device 140, provider exchange system 110 of FIG. 1) as a hosted website and is accessible by the user device via a network (e.g., network 130 of FIG. 1).

In some arrangements, the graphical user interface 400 facilitates user registration of an account and/or linking of an existing or previously-created user account with a merchant to a user account with a provider (e.g., a provider account). For example, the user may have an account with login credentials (e.g., merchant username and merchant passcode) and/or additional user data stored in a database (e.g., exchange dataset 122 or account dataset 124 of FIG. 1), and account data and/or login credentials may be accessed (e.g., in response to the user interacting with an element or item of the graphical user interface 400). In some arrangements, the graphical user interface 400 may include content items and actionable elements with content, and the user may view the content of the actionable items or the content items to determine exchange or account information (e.g., whether the user has an account with a merchant corresponding to an exchange between the user and merchant facilitated by the provider), or may interact with the actionable items to perform various tasks and/or processes or to cause the provider exchange system 110 to link accounts, updating exchange history or account data, determine exchange rewards, provide scannable codes (e.g., QR codes, barcodes, etc.), and more. In some arrangements, the interactive elements (e.g., actionable element, input field, content item, etc.) can receive an input (e.g., via a user interacting with user device 140), and the application 142 can update the interactive elements dynamically as the user inputs (or interacts) with the interactive element. In various arrangements, various pages (e.g., exchange pages, point redemption pages, etc.) can be displayed by application 142 and may include an individual interface such as a first application user interface, a second application interface, a third application interface, and so on. That is, generating or providing one or more actionable elements or content items corresponding with an exchange can be provided by application 142 for display via GUI 400. For example, similar to generating one or more actionable elements corresponding with a first unlinked exchange or corresponding with a second unlinked exchange, the application 142 can create and provide various actionable elements or content items displayed on the GUI 400 (e.g., for user interaction, to display information, etc.).

In some arrangements, once the user provides an input to various interactive elements (e.g., actionable elements) in the graphical user interface 400, one or more computing devices (e.g., user device 140 or provider exchange system 110 of FIG. 1) may provide (e.g., over network 130) the input for storage and/or analysis (e.g., for storing linked and unlinked account data, exchange data, merchant parameters, exchange parameters, exchange rates, etc.). In various arrangements, a user may be associated with an account (e.g., a provider account, a merchant account, etc.), and the user may cause the provider exchange system 110 to manage (e.g., update, synchronize, link, etc.) various data associated with the account by the user interacting with the (e.g., providing input to) graphical user interface 400. The application 142 can provide the graphical user interface 400 for managing or causing the linking of exchanges and/or accounts, which can include, but is not limited to, causing the application 142 and/or provider exchange system 110 to add new exchanges to a provider database, remove exchanges, change account or user preferences (e.g., general, payment), determine reward eligibility/account eligibility for rewards, redeem rewards, and so on. That is, receiving a selection of one or more actionable elements for various purposes can be provided on GUI 400. For example, similar to receiving a selection of the one or more actionable elements corresponding with a request to link or create an account, the application 142 can receive data (e.g., user input) provided by the user from interacting with the various actionable elements of the GUI 400, as further described here.

Referring to FIGS. 4A-4C in more detail, FIG. 4A illustrates the graphical user interface 400, which may be displayed by application 142 in response to a user navigating to a provider or merchant webpage or accessing a user or provider application on user device 140 (e.g., a mobile banking application). As shown, the graphical user interface 400 may include a plurality of interactive or actionable elements, such as QRs element 402 and A+element 404. Interactive elements (sometimes referred to herein as “actionable elements” or “input fields”) can include, but are not limited to, text input, buttons, drop-downs, links, speech-to-text, and so on. Furthermore, various interactive elements are contemplated in this disclosure. For example, the application 142 may receive a user selection (e.g., via a touchscreen) of the QRs element 402 in response to the user interacting with a touchscreen display of the mobile electronic device 140 presenting the element. That is, providing a first scannable code to a GUI can be provided on GUI 400. For example, similar to providing a first scannable code to a GUI of the provider mobile application 142, the application 142 map update the GUI to present a scannable code (e.g., barcode, QR code, etc.) in response the user interacting with the QRs element 402. That is, providing a login interface via a data communications link may be provided on GUI 400. For example, similar to providing, via a data communications link with a merchant computing system of a first merchant, a login interface of a first merchant in the provider application 142, the GUI may present a login page and/or various login elements in response to the user interacting with (e.g., selecting) the A+ element 404.

In some arrangements, the graphical user interface 400 may include a variety of content, such as one or more content items or content of actionable elements. In some arrangements, the content may include information such as a total balance, environmental information such as current date/time and/or device battery status, and other information related to exchanges and/or accounts or related to the user and/or provider (e.g., provider logo, provider account username, etc.). For example, as shown on FIG. 4A, the graphical user interface 400 may include a list of transactions/exchanges (e.g., exchange history data 406), which may include a log of past and/or pending exchanges between the user and various merchants, and which may be presented by the application 142 executing on the user device 140 to the user for viewing. For instance, in one particular example the GUI 400 may correspond to a mobile banking application, and the list of transactions/exchanges may be a list of purchases, payments, fees, and/or interest charges corresponding to transaction card activity (e.g., credit card activity or debit card activity). In some arrangements, the exchange history data 406 may include one or more exchanges 408a-408n (collectively “exchanges 408”). That is, identifying one or more exchanges between a user and a merchant based on exchange history data of the user can be provided on GUI 400. For example, similar to identifying at least one first exchange, the application 142 can update the GUI 400 to display the exchange history data 406 including multiple exchanges to facilitate identification of an exchange between a user and merchant with an unlinked user account.

In some arrangements, the graphical user interface 400 may include content items or actionable elements describing exchanges and/or information corresponding to exchanges (e.g., user ID, merchant ID, exchange date, total amount, rewards earned, linked or unlinked statuses, account credentials, etc.). For example, as shown on FIG. 4A, the graphical user interface 400 includes various content corresponding to the exchanges 408, such as merchant names (“Fargo Eatery), linked or unlinked account information (e.g., “Unlinked”), and exchange amounts (e.g., “$60.02”).

In one example, the provider exchange system 110 can analyze the exchanges 408 and extract information such as merchant names for determining and/or identifying unlinked merchant accounts associated with the user. For example, if the provider exchange system scans the exchanges 408 and identifies a transaction corresponding with the merchant “Fargo Eatery,” the provider exchange system 110 can check whether the user has an account with Fargo Eatery linked to the provider exchange system 110 by querying internal records (e.g., stored in database 120) or communicating with the third-party computing system 150 (e.g., via an API call). If the provider exchange system 110 determines the user's merchant account with Fargo Eatery is unlinked, the provider exchange system 110 can present the merchant name and/or instructions for the user to link the merchant account via the GUI 400. Further, the provider exchange system 110 can assess whether the user has any redeemable rewards by querying the merchant's rewards system or checking pre-stored information, and if rewards are found, the provider exchange system 110 can transmit such rewards information (e.g., balance, number of points, etc.) and/or notify the user of such rewards via the application 142 on the user device 140. While in some examples merchant identifying information may include a merchant name associated with a particular transaction/exchange, in other examples, linked and/or unlinked merchants may be identified based on a merchant description or a billing descriptor associated with a particular transaction/exchange. For instance, a four-digital merchant code may be utilized to help identify if a merchant is linked or unlinked, while in other examples, transactions/exchanges may be associated with a merchant's location or customer service number that may be utilized.

In some arrangements, the exchanges 408 may correspond with one or more actionable elements 410a-410n (collectively “actionable elements 410”) for viewing or linking merchants/merchant accounts corresponding to the exchanges 410 with a provider account of the user with the provider. Content of the actionable elements 410 may include the merchant name, linked or unlinked account information, exchange amount, and so on. In some arrangements, the graphical user interface 400 may further include additional actionable elements or content items, such as one or more elements to cause the application 142 to access user accounts (e.g., “My Accounts’ or “Accounts”), to facilitate an exchange (e.g., “Send+Request), to access a home page of the provider (e.g., “Home”), or to adjust settings of the graphical user interface 400 and/or the provider application 142 presenting the graphical user interface 400. That is, linking the provider account of the user with an account or new account of the user with a first merchant, second merchant, third merchant, etc. may be provided on GUI 400. For example, similar to linking the provider account of the user with the first account or the new first account of the user with the first merchant or the provider account of the user with the second account or the new second account of the user with the second merchant, the application 142 may cause the GUI 400 to present the actionable elements 410 to cause provider exchange system 110 to link and/or synchronize various user accounts with a merchant with a user account with a provider (e.g., by providing a merchant login interface, presenting additional actionable elements for linking each account, etc.).

In some arrangements, in response to a user selecting (e.g., clicking with a mouse, touching with a finger on a touchpad, etc.) the actionable element 410a, the application 142 can update the graphical user interface 400 to provide a points content item 412 corresponding to the exchange 408a (e.g., Transaction #53214), a setup account element 413, a link account element 414, and various other content items and/or actionable elements, as shown. For example, the graphical user interface 400 may include an exchange reward or points content item (e.g., “You've earned 60 points”), transaction/exchange details (e.g., exchange amount, etc.), user input features for setting up or linking an account with a provider (e.g., setup account element 413 and link account element 414), and more. That is, generating one or more actionable elements corresponding with an unlinked exchange can be provided on GUI 400. For example, similar to generating one or more actionable elements corresponding with the first unlinked exchange, the application 142 can update GUI 400 to display or provide the link account element 414 to the user for linking the first account or registering a new first account.

In some arrangements, in response to the user interacting with one or more actionable elements of the graphical user interface 400, the application 142 may update the graphical user interface 400 to provide various content items and/or actionable elements for synchronizing or linking user accounts. For example, in response to the user selecting one or more of the setup account element 413 or the link account element 414, the mobile device 140 may establish a data communications link between the provider exchange system 110/provider mobile application 142 and a merchant computing system and/or a merchant application (e.g., third party computing system 150 and a corresponding merchant application). Further, the graphical user interface 400 may display a merchant login page (e.g., merchant login portal) including various content (e.g., content items) and user input fields (e.g., actionable elements). For example, the merchant login page may include a username element 420a (e.g., for a user to input an account username) and a passcode element 422a (e.g., for user to input an account password or passcode). Further, a user may interact (e.g., select, press, etc.) with a link element 424a to provide inputted information from the username element 420a and the passcode element 422a to the provider exchange system 110 for authentication). That is, transmitting or receiving an authorization code and/or access token for linking user accounts may be provided on GUI 400. For example, similar to receiving, in response to the user inputting login credentials using the login interface, an authorization code comprising at least one of a QR code, a bar code, a numerical and/or character code, or biometric identifier to identify and authenticate a user session, the mobile device 140 executing the GUI 400 may receive an authorization code or other login data (e.g., access token, key, etc.) for synchronizing or linking a user account corresponding to credentials entered in the username element 420a and the passcode element 422a.

Referring now to FIG. 4B, in response to a user selecting (e.g., clicking with a mouse, touching with a finger on a touchpad, etc.) the actionable element 410a, the graphical user interface 400 may display the points content item 412 corresponding to the exchange 408a (e.g., Transaction #53214), a linked or unlinked account element 416, a redeem points element 420, and various other content items and/or actionable elements, as shown. For example, the application 142 may cause graphical user interface 400 to update one or more of the actionable elements or content items corresponding to a previously unlinked user account with a merchant to indicate a successful linking of the user account with the merchant to the user account with the provider. As shown in FIG. 4B, for example, the application 142 can update content of the actionable element 410a corresponding to the exchange 408a may transition from displaying “Unlinked” to displaying “Linked” in response to the user linking a merchant account corresponding to the exchange with the provider account (e.g., as described regarding the merchant login page of FIG. 4A). In some arrangements, the application 142 can update other data (e.g., data stored in a data store accessible to the mobile device 140 executing the graphical user interface 400) to correspond to a linked or unlinked user account. That is, updating the content of actionable elements or presenting content may be provided on GUI 400. For example, similar to updating the content of the one or more actionable elements of the GUI indicating a link between the first account of the user or new first account of the user with first merchant, the at least one second exchange, and the provider account of the user with the provider, the application 142 can cause the GUI 400 to update content of the actionable element 410a presented (e.g., including merchant data and account data) the updated actionable element 410a to reflect account linkage and/or synchronization.

In some arrangements, in response to a user selecting the redeem points element 420, the application 142 may cause the graphical user interface 400 to provide or display various actionable elements, such as a first redemption element 424a (e.g., “Free Drink—50 Points” button) and a second redemption element 424b (e.g., “Free Meal—200 Points” button). The graphical user interface 400 can also include various content items, such as scannable code 426 (e.g., a barcode). In some arrangements, in response to the application 142 receiving a selection of various actionable elements or content items of the redeem points page 422 (e.g., first redemption element 424a, second redemption element 424b, scannable code 426), the application 142 may update the GUI 400 to direct the user may to another page of the GUI 400 for redeeming rewards points (e.g., exchange points, transaction points, exchange earnings, points, rewards, etc.), as further described below. That is, providing exchange rewards to the user can be provided on the GUI 400. For example, similar to providing exchange rewards to the user in response to linking of an account or a new account, the application 142 can update the GUI 400 to provide various actionable elements (e.g., redeem points element 420, first redemption element 424a, second redemption element 424b, etc.) for redeeming rewards points. In some arrangements, a merchant (e.g., vendor) may scan the scannable code 426 presented on the user device 140 to determine various rewards information (e.g., user rewards balance, eligibility parameters, etc.) or to facilitate the user redeeming earned exchanged rewards.

Referring now to FIG. 4C, in response to a user interacting with various interactive elements or items of the graphical user interface 400 (e.g., selecting first redemption element 424a or second redemption element 424b, scanning scannable code 426 using a camera or built-in code recognition functionality of the mobile device 140, etc.), the application 142 may cause the graphical user interface 400 to provide or display a first merchant element 434a, a second merchant element 434b, and an add accounts element 436. In some arrangements, a user can interact with the add accounts element 436 to cause the application 142 to display a merchant login page, as described above regarding the merchant login page of FIG. 4A. In another example, the user may select the first merchant element 434a or second merchant element 434b to cause the application 142 to update the GUI 400 to display a respective code page corresponding to the selected merchant. For example, in response to the user selecting the first merchant element 434a, the application 142 may provide the graphical user interface 400 may displaying a scannable code 440 for a user to scan for earning or receiving rewards associated with the first merchant and the provider. For example, the scannable code 440 may be a QR code configured to be scanned by and/or inputted into a computing device (e.g., using a camera) to determine rewards information contained therein (e.g., to determine exchange rewards). That is, generating one or more content items corresponding to an exchange reward amount may be provided on GUI 400. For example, similar to retrieving an exchange reward amount by interfacing with an API of a merchant computing system of a merchant and generating one or more content items corresponding to the exchange reward amount, the application 142 may cause the GUI 400 to create and present the scannable code 440 in response to a user interacting with or selecting the second merchant element 434b based on data received via a data communications link between the user device 140 and a merchant computing system of the second merchant.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein. It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function. Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method, comprising:
identifying, by one or more processing circuits, at least one first exchange between a user and a first merchant based on exchange history data of the user, the at least one first exchange linked to a provider account of the user with a provider;
determining, by the one or more processing circuits, the first merchant corresponds to an exchange rewards system enrolled with the provider;
in response to identifying at least one first exchange, determining, by the one or more processing circuits, the at least one first exchange is a first unlinked exchange of the provider account and the first merchant;
generating, by the one or more processing circuits, one or more actionable elements corresponding with the first unlinked exchange, wherein at least one of the one or more actionable elements corresponds with linking the provider account of the user with a first account of the user with the first merchant or registering a new account of the user with the first merchant;
providing, by the one or more processing circuits, the one or more actionable elements to a graphical user interface (GUI) of a provider mobile application associated with the provider;
receiving, by the one or more processing circuits, a selection of the one or more actionable elements corresponding with a first request to link the provider account of the user with the first account of the user with the first merchant or register the new account of the user with the first merchant;
establishing, by the one or more processing circuits, a data communications link with a merchant computing system associated with the first merchant;
linking, by the one or more processing circuits, the provider account of the user with the first account or the new account of the user and with the exchange rewards system associated with the first merchant; and
updating, by the one or more processing circuits, content of the one or more actionable elements of the GUI indicating a successful linking of the first account or the new account to the provider.

2. The method of claim 1, further comprising:
identifying, by the one or more processing circuits, at least one second exchange linked to the provider account of the user, wherein the at least one second exchange is a second unlinked exchange of the provider account and a second merchant;
determining, by the one or more processing circuits, the second merchant corresponds to a second exchange rewards system enrolled with the provider;
generating, by the one or more processing circuits, one or more content items corresponding to one or more unlinked user accounts based on the first unlinked exchange and the second unlinked exchange; and
providing, by the one or more processing circuits, the one or more content items corresponding to the one or more unlinked user accounts to the GUI in a viewport of the provider mobile application.

3. The method of claim 2, further comprising:
updating, by the one or more processing circuits, the content of the one or more actionable elements prompting the user to select the first merchant or the second merchant for linking;
receiving, by the one or more processing circuits, a first selection of the one or more actionable elements corresponding with a second request to link the first account of the user with the first merchant or register the new account of the user with the first merchant or a second selection of the one or more actionable elements corresponding with a third request to link a second account of the user with the second merchant or register a new second account of the user with the second merchant; and
linking, by the one or processing circuits, the provider account of the user with the second account or the new second account of the user with the second merchant and with the second exchange rewards system associated with the second merchant.

4. The method of claim 1, wherein linking comprises:
providing, by the one or more processing circuits via the data communications link with the merchant computing system of the first merchant, a login interface of the first merchant in a viewport of the provider mobile application;
in response to the user inputting login credentials using the login interface, receiving, by the one or more processing circuits and via the data communications link, an authorization code to identify and authenticate a user login session with the merchant computing system of the first merchant;
transmitting, by the one or more processing circuits and via the data communications link, the authorization code to the merchant computing system;
receiving, by the one or more processing circuits and via the data communications link, an access token for accessing the first account of the user with the first merchant or the new first account of the user with the first merchant, wherein receiving the access token is responsive to the merchant computing system validating the authorization code and generating the access token; and
receiving, by the one or more processing circuits and via the data communications link, account data and exchange data in exchange for providing the access token to the merchant computing system.

5. The method of claim 1, further comprising:
receiving, by the one or more processing circuits and via the data communications link, at least one second exchange between the user and the first merchant;
determining, by the one or more processing circuits, the at least one second exchange is linked to the provider account of the user with the provider, wherein the determining comprises identifying the first account of the user with the first merchant or the new first account of the user with the first merchant;
updating, by the one or more processing circuits, the content of the one or more actionable elements of the GUI indicating a link between the first account of the user or new first account of the user with first merchant, the at least one second exchange, and the provider account of the user with the provider; and
presenting, by the one or more processing circuits, the content comprising merchant data and account data to the GUI in a viewport of the provider mobile application.

6. The method of claim 1, further comprising:
in response to linking of the first account or the new first account, providing, by the one or more processing circuits, exchange rewards to the user, wherein providing the exchange rewards comprises:
identifying, by the one or more processing circuits, an exchange amount of the at least one first exchange;
receiving, by the one or more processing circuits via the data communications link, one or more merchant parameters;
determining, by the one or more processing circuits, an exchange reward amount based on the exchange amount and at least one of the one or more merchant parameters;
generating, by the one or more processing circuits, one or more content items corresponding to the exchange reward amount; and
providing, by the one or more processing circuits, the one or more content items corresponding to the exchange reward amount to the GUI in a viewport of the provider mobile application.

7. The method of claim 1, further comprising:
in response to linking of the first account or the new first account, providing, by the one or more processing circuits, exchange rewards to the user, wherein providing the exchange rewards comprises:
accessing, by the one or more processing circuits, the first account of the user with the first merchant or the first new account of the user with the first merchant via the data communications link;
retrieving, by the one or more processing circuits, an exchange reward amount from the first account or the first new account, wherein retrieving comprising interfacing with an application programming interface (API) of the merchant computing system of the first merchant;
generating, by the one or more processing circuits, one or more content items corresponding to the exchange reward amount; and
providing, by the one or more processing circuits, the one or more content items corresponding to the exchange reward amount to the GUI in a viewport of the provider mobile application.

8. The method of claim 1, further comprising:
generating, by the one or more processing circuits, a first scannable code of the first account or the new first account of the user with the first merchant, wherein the first scannable code is unique to the provider account of the user with the provider, and wherein the first scannable code is different from a second scannable code of the first account or new first account of the user of a merchant mobile application of the first merchant;
in response to receiving the selection of the one or more actionable elements corresponding with a first request to link the first account of the user with the first merchant or register the new first account of the user with the first merchant, providing, by the one or more processing circuits, the first scannable code to the GUI in a viewport of the provider mobile application.

9. The method of claim 1, further comprising:
generating, by the one or more processing circuits, the one or more actionable elements of the GUI based on linked account information, wherein the linked account information comprises data of a plurality of merchants comprising linked user accounts and unlinked user accounts with the provider account, and wherein generating comprises updating the content of at least one of the one or more actionable elements to indicate an unlinked account of at least one or the plurality of merchants; and
in response to the user interacting at least one of the one or more actionable elements, providing, by the one or more processing circuits via the provider mobile application, a message prompting the user to provide account credentials for linking at least one unlinked user account with the provider account.

10. A computing system, comprising:
one or more processing circuits comprising one or more processors coupled to one or more memory devices, the one or more processing circuits configured to:
identify at least one first exchange between a user and a first merchant based on exchange history data of the user, the at least one first exchange linked to a provider account of the user with a provider;
determine the first merchant corresponds to an exchange rewards system enrolled with the provider;
in response to identifying at least one first exchange, determine the at least one first exchange is a first unlinked exchange of the provider account and the first merchant;
generate one or more actionable elements corresponding with the first unlinked exchange, wherein at least one of the one or more actionable elements corresponds with linking the provider account of the user with a first account of the user with the first merchant or registering a new account of the user with the first merchant;
provide the one or more actionable elements to a graphical user interface (GUI) of a provider application associated with the provider;
receive a selection of the one or more actionable elements corresponding with a first request to link the provider account of the user with the first merchant or register the new account of the user with the first merchant;
establish a data communications link with a merchant computing system associated with the first merchant;
link the provider account of the user with the first account or the new account of the user with the first merchant and with the exchange rewards system associated with the first merchant; and
update content of the one or more actionable elements of the GUI indicating a successful linking of the first account or the new first account to the provider account.

11. The computing system of claim 10, wherein the one or more processing circuits are further configured to:
identify at least one second exchange linked to the provider account of the user, wherein the at least one second exchange is a second unlinked exchange of the provider account between a second merchant and the user;
determine the second merchant corresponds to a second exchange rewards system enrolled with the provider;
generate one or more content items corresponding to one or more unlinked user accounts based on the first unlinked exchange and the second unlinked exchange; and
provide the one or more content items corresponding to the one or more unlinked user accounts to the GUI in a viewport of the provider mobile application.

12. The computing system of claim 11, wherein the one or more processing circuits are further configured to:
update the content of the one or more actionable elements prompting the user to select the first merchant or the second merchant for linking;
receive a first selection of the one or more actionable elements corresponding with a second request to link the first account of the user with the first merchant or register the new account of the user with the first merchant or a second selection of the one or more actionable elements corresponding with a third request to link a second account of the user with the second merchant or register a new second account of the user with the second merchant; and
link the provider account of the user with the second account or the new second account of the user with the second merchant and with the second exchange rewards system associated with the second merchant.

13. The computing system of claim 10, wherein the one or more processing circuits are further configured to:
provide, via the data communications link with the merchant computing system of the first merchant, a login interface of the first merchant in a viewport of the provider mobile application;
in response to the user inputting login credentials using the login interface, receive, via the data communications link, an authorization code to identify and authenticate a user login session with the merchant computing system of the first merchant;
transmit, via the data communications link, the authorization code to the merchant computing system;
receive, via the data communications link, an access token for accessing the first account of the user with the first merchant or the new first account of the user with the first merchant, wherein receiving the access token is responsive to the merchant computing system validating the authorization code and generating the access token; and
receive, via the data communications link, account data and exchange data in exchange for providing the access token to the merchant computing system.

14. The computing system of claim 10, wherein the one or more processing circuits are further configured to:
receive, via the data communications link, at least one second exchange between the user and the first merchant;
determine the at least one second exchange is linked to the provider account of the user with the provider, wherein the determining comprises identifying the first account of the user with the first merchant or the new first account of the user with the first merchant;
update the content of the one or more actionable elements of the GUI indicating a link between the first account of the user or new first account of the user with first merchant, the at least one second exchange, and the provider account of the user with the provider; and
present the content comprising merchant data and account data to the GUI in a viewport of the provider mobile application.

15. The computing system of claim 10, wherein the one or more processing circuits are further configured to:
in response to linking of the first account or the new first account, provide exchange rewards to the user, wherein the one or more processing circuits are configured to:
identify an exchange amount of the at least one first exchange;
receive, via the data communications link, one or more merchant parameters;
determine an exchange reward amount based on the exchange amount and at least one of the one or more merchant parameters;
generate one or more content items corresponding to the exchange reward amount; and
provide the one or more content items corresponding to the exchange reward amount to the GUI in a viewport of the provider mobile application.

16. The computing system of claim 10, wherein the one or more processing circuits are further configured to:
in response to linking of the first account or the new first account, provide exchange rewards to the user, wherein the one or more processing circuits are configured to:
access the first account of the user with the first merchant or the first new account of the user with the first merchant via the data communications link;
retrieve an exchange reward amount from the first account or the first new account, wherein retrieving comprising interfacing with an application programming interface (API) of the merchant computing system of the first merchant;
generate one or more content items corresponding to the exchange reward amount; and
provide the one or more content items corresponding to the exchange reward amount to the GUI in a viewport of the provider mobile application.

17. The computing system of claim 10, wherein the one or more processing circuits are further configured to:
generate a first scannable code of the first account or the new first account of the user with the first merchant, wherein the first scannable code is unique to the provider account of the user with the provider, and wherein the first scannable code is different from a second scannable code of the first account or new first account of the user of a merchant mobile application of the first merchant;
in response to receiving the selection of the one or more actionable elements corresponding with a first request to link the first account of the user with the first merchant or register the new first account of the user with the first merchant, provide the first scannable code to the GUI in a viewport of the provider mobile application.

18. The computing system of claim 10, wherein the one or more processing circuits are further configured to:
generate the one or more actionable elements of the GUI based on linked account information, wherein the linked account information comprises data of a plurality of merchants comprising linked user accounts and unlinked user accounts with the provider account, and wherein generating comprises updating the content of at least one of the one or more actionable elements to indicate an unlinked account of at least one or the plurality of merchants; and
in response to the user interacting at least one of the one or more actionable elements, provide, via the provider mobile application, a message prompting the user to provide account credentials for linking at least one unlinked user account with the provider account.

19. One or more non-transitory computer-readable media (CRM) having instructions stored thereon that, when executed by one or more processing circuits, cause the one or more processing circuits to perform operations comprising:
identifying at least one first exchange between a user and a first merchant based on exchange history data of the user, the at least one first exchange linked to a provider account of the user with a provider;
determine the first merchant corresponds to an exchange rewards system enrolled with the provider;
in response to identifying at least one first exchange, determining the at least one first exchange is a first unlinked exchange of the provider account and the first merchant;
generating one or more actionable elements corresponding with the first unlinked exchange, wherein at least one of the one or more actionable elements corresponds with linking the provider account of the user with a first account of the user with the first merchant or registering a new account of the user with the first merchant;
providing, to a user device associated with the user, the one or more actionable elements to a graphical user interface (GUI);
receiving a selection of the one or more actionable elements corresponding with a first request to link the provider account of the user with the first account of the user with the first merchant or register the new account of the user with the first merchant;
establishing a data communications link with a merchant computing system of the first merchant;
linking the provider account of the user with the first account or the new first account of the user with the first merchant; and
updating content of the one or more actionable elements of the GUI indicating a successful linking of the first account or the new first account.

20. The one or more non-transitory CRM of claim 19, wherein the instructions, when executed by one or more processing circuits, further cause the one or more processing circuits to perform operations comprising:
identifying at least one second exchange linked to the provider account of the user, wherein the at least one second exchange is a second unlinked exchange of the provider account between a second merchant and the user;
determining the second merchant corresponds to a second exchange rewards system enrolled with the provider;
generating one or more content items corresponding to one or more unlinked user accounts based on the first unlinked exchange and the second unlinked exchange; and
providing the one or more content items corresponding to the one or more unlinked user accounts to the GUI in a viewport of a provider mobile application.
